(19) United States
(12) Patent Application Publication
(10) Pub. No.: US 2016/0098197 A1
(43) Pub. Date: Apr. 7, 2016

(54) NONVOLATILE MEMORY AND METHOD WITH STATE ENCODING AND PAGE-BY-PAGE PROGRAMMING YIELDING INVARIANT READ POINTS

(71) Applicant: SanDisk Technologies, Inc., Plano, TX (US)

(72) Inventors: Tien-chien Kuo, Sunnyvale, CA (US); Yee-Lih Koh, Fremont, CA (US)

(21) Appl. No.: 14/507,541

(22) Filed: Oct. 6, 2014

(51) Int. Cl. G06F 3/06

(52) U.S. Cl. CPC G06F 3/0604; G06F 3/0634; G06F 3/0679

(57) ABSTRACT

A flash memory allows a range of charges to be programmed into its cells to represent 8 distinct memory states, which are encoded by 3 bits (upper, middle, lower) of data. A page of memory cells which is programmed or read in parallel yields corresponding upper, middle and lower data pages. In page-by-page schemes, each data page can be programmed and read independently. Each data page has a predetermined set of read points to distinguish between “1” and “0” bits. Prior state encodings have to use different sets of read points for a lower data page depending on whether or not the higher data pages are already programmed, as indicated by maintaining a flag. The present programming and state encoding schemes have invariant read points, independent of the program status of the higher order pages and do not require maintaining a flag, thereby improving read performance.

### BACKGROUND

This application relates generally to two- or three-dimensional nonvolatile memory systems such as semiconductor flash memory with charge storage elements as memory cells, and more particularly to page-by-page state encoding, programming and reading of multi-level memory cells using invariant read points.

Solid-state memory capable of nonvolatile storage of charge, particularly in the form of EEPROM and flash EEPROM packaged as a small form factor card, has become the storage of choice in a variety of mobile and handheld devices, notably information appliances and consumer electronics products. Unlike RAM (random access memory) that is also solid-state memory, flash memory is non-volatile, and retains its stored data even after power is turned off. Also, unlike ROM (read only memory), flash memory is rewritable similar to a disk storage device. In spite of the higher cost, flash memory is increasingly being used in mass storage applications.

Flash EEPROM is similar to EEPROM (electrically erasable and programmable read-only memory) in that it is a non-volatile memory that can be erased and have new data written or “programmed” into their memory cells. Both utilize a floating (unconnected) conductive gate, in a field effect transistor structure, positioned over a channel region in a semiconductor substrate, between source and drain regions. A control gate is then provided over the floating gate. The threshold voltage characteristic of the transistor is controlled by the amount of charge that is retained on the floating gate. That is, for a given level of charge on the floating gate, there is a corresponding voltage (threshold) that must be applied to the control gate before the transistor is turned “on” to permit conduction between its source and drain regions. Flash memory such as Flash EEPROM allows entire blocks of memory cells to be erased at the same time.

The floating gate can hold a range of charges and therefore can be programmed to any threshold voltage level within a threshold voltage window. The size of the threshold voltage window is delimited by the minimum and maximum threshold levels of the device, which in turn correspond to the range of the charges that can be programmed onto the floating gate. The threshold window generally depends on the memory device's characteristics, operating conditions and history. Each distinct, resolvable threshold voltage level range within the window may, in principle, be used to designate a definite memory state of the cell.

Nonvolatile memory devices are also manufactured from memory cells with a dielectric layer for storing charge. Instead of the conductive floating gate elements described earlier, a dielectric layer is used. Such memory devices utilizing dielectric storage element have been described by Eitan et al., “NROM: A Novel Localized Trapping, 2-Bit Nonvolatile Memory Cell,” IEEE Electron Device Letters, vol. 21, no. 11, November 2000, pp. 543-545. An ONO dielectric layer extends across the channel between source and drain diffusions. The charge for one data bit is localized in the dielectric layer adjacent to the drain, and the charge for the other data bit is localized in the dielectric layer adjacent to the source. For example, U.S. Pat. Nos. 5,768,192 and 6,011,725 disclose a nonvolatile memory cell having a trapping dielectric sandwiched between two silicon dioxide layers. Multi-state data storage is implemented by separately reading the binary states of the spatially separated charge storage regions within the dielectric.

A flash memory allows a range of charges to be programmed into its cells to represent S distinct memory states, which are encoded by n bits (where 2ⁿ=S) of data. For example, an 8-state memory cell would have the eight states encoded by 3 bits. A page of memory cells which is programmed or read in parallel yields corresponding upper, middle and lower data pages, corresponding to the upper, middle and lower bits of each memory cell of the page. In page-by-page schemes, each data page can be programmed and read independently.

Each data page has a set of predetermined read points to distinguish between “1” and “0” bits. However, for nonvolatile memory having tri-level-cells (TLC, 3 bits per cell) that allows page by page operations, read levels are different depending on how many pages are programmed on the selected word line WL. In order to judge the number of pages programmed and determine the read level accordingly, the current solution is to assign two bytes per WL as the “LM flags”. These LM flag bytes get programmed only during upper page program. When reading a lower page, it is assumed by default that the upper page is already programmed and the set of predetermined read points associated with when the upper pages are already programmed are used. By checking the read result of these LM flags, it is possible to determine whether upper page is programmed, and hence the default read levels are correct. If the LM flag indicates otherwise, a different set of predetermined read points associated with when the upper pages have not been programmed are used.

However, as feature size shrinks, correctly reading these LM flag bytes is more and more challenging. The problem is exacerbated also because there is no ECC correction when checking the LM flags. There are several known noise factors, including read disturb, data retention, no NAND-chain direction randomness. Other concerns and overheads includes: the need to have some special circuits to guarantee that these LM flag bytes are good and special circuit to check the result of a LM flag. Also as feature size shrinks, floating-gate to floating-gate coupling leads to read errors and are compensated by a look-ahead technique, which requires also reading an adjacent word line. As indicated in U.S. Pat. No. 7,447,078 B2, state encoding using different sets of read points dependent on whether or not the larger pages have been programmed and managing LM flags complicate matters and compromise performance.

### SUMMARY OF THE INVENTION

A flash memory allows a range of charges to be programmed into its cells to represent 8 distinct memory states, which are encoded by 3 bits (upper, middle, lower) of data. A physical page of memory cells which is programmed or read in parallel yields corresponding upper, middle and lower data pages. In page-by-page schemes, each physical page of memory cells can be programmed in order of lower, middle and upper data pages, and each data page can be read independently even if a higher order page has not yet been programmed. Each data page has a set of predetermined read points to distinguish between “1” and “0” bits. Prior state encodings have to use different sets of read points for a lower data page depending on whether or not the higher order data pages are already programmed, as indicated by maintaining a flag. The present programming and state encoding schemes have invariant read points, independent of the program status of the higher order pages and do not require maintaining a flag, thereby improving read performance.

The flash memory has an array of memory cells, wherein individual memory cells are each in one of eight memory states, the eight memory states being an erase state and seven programmed states with increasing threshold values across a threshold window; a group of data latches for storing each bit of a 3-bit code word for each memory cell among a group of memory cells operating in parallel, the 3-bit code word being one of eight 3-bit code words generated from a 3-bit code to encode the eight memory states; the 3-bit code being constituted from a lower bit, a middle bit and an upper bit, wherein a lower page, middle page and upper page of data are respectively constituted from the lower bit, middle bit and upper bit of each memory cell among the group; read circuits for reading page by page, the lower, middle or upper pages each being read by reference to a respective set of read points of predetermined threshold values; programming circuits for programming the group of memory cells in parallel, page by page, in order of the lower page, the middle page and then the upper page; and wherein the respective set of read points for each of the lower, middle or upper pages is invariant irrespective of whether a higher order page has been programmed or not.

Additionally, the programming circuits of the flash memory performs programming of the group of memory cells in parallel, page by page, in order of the lower page, the middle page and then the upper page, said programming for each page increasing the threshold values of the group of memory cells in such a way that the respective set of read points for each of the lower, middle or upper pages is invariant irrespective of whether a higher order page has been programmed or not.

Examples of three state encodings and associated programming schemes, such as a “2-3-2” coding, a “4-2-1” coding and a “2-1-4” coding, have an invariant set of read points for each of the lower, middle and upper pages.

A method of operating the flash memory includes encoding the eight memory states with eight 3-bit code words with a predefined ordering; each 3-bit code word having a lower bit, a middle bit and an upper bit, and wherein a group of memory cells has a lower page, middle page and upper page of data are respectively constituted from the lower bit, middle bit and upper bit of each memory cell among the group; programming the group of memory cells in parallel, page by page, in order of the lower page, the middle page and then the upper page, said programming for each page increasing the threshold value of the group of memory cells in such a way that the respective set of read points for each of the lower, middle or upper pages is invariant irrespective of whether a higher order page has been programmed or not; and reading page by page, the lower, middle or upper pages each being read by reference to a respective set of read points of predefined threshold values.

The advantage of page-by-page operation on a physical page of memory cells is that for multi-level cells such that those that store three bit per memory cell, it is more flexible to be able to use the page of memory cells when not all order of data pages have been programmed. Thus, it is possible to immediately use a lower page even when the middle and upper pages are not yet programmed. However, when reading page-by-page, prior encodings and programming schemes yield sets of read points that are dependent on the program status of the higher order pages. An LM flag indicating such status needs to be maintained to enable the correct set of read points. This would require additional reads to retrieve the LM flag.

The advantage of the present flash memory and scheme is that the set of read points are independent of the program status of the higher order pages. Thus, no LM flag is needed. Furthermore the encodings with invariant read points.

Various aspects, advantages, features and embodiments are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

FIG. 1 illustrates schematically the main hardware components of a memory system suitable for implementing the present subject matter.

FIG. 2 illustrates schematically a non-volatile memory cell.

FIG. 3 illustrates the relation between the source-drain current I_{D} and the control gate voltage V_{CG} for four different charges Q1-Q4 that the floating gate may be selectively storing at any one time at fixed drain voltage.

FIG. 4A illustrates schematically a daisy chain of memory cells organized into a NAND string.

FIG. 4B illustrates an example of a NAND array of memory cells, constituted from NAND strings such as that shown in FIG. 4A.

FIG. 5 illustrates a page of memory cells, organized in the NAND configuration, being sensed or programmed in parallel.

FIG. 6 illustrates an oblique projection of a part of a 3D NAND memory.

FIG. 7(0) illustrates the threshold voltage distributions of an 8-state memory array.

FIG. 7(1) illustrates that prior to programming a population of memory cells, the memory cells are in an erase state.

FIG. 7(2) illustrates that in a full-sequence programming, each of the memory states are programmed directly from the erased state.

FIG. 8 illustrates the read points for each of the data pages with the 1-2-4 coding after a full-sequence programming.

FIG. 9(0) illustrates the threshold voltage distributions of an 8-state memory array, similar to FIG. 7(0).

FIG. 9(1) illustrates that the population of memory cells to be programmed are initially at an erased state.

FIG. 9(2) illustrates the lower page programming with the 1-2-4 coding.

FIG. 9(3) illustrates the middle page programming with the 1-2-4 coding.

FIG. 9(4) illustrates the upper page programming with the 1-2-4 coding.

FIG. 10A illustrates the read points for reading the lower page in the 1-2-4 coding when the middle and upper pages have not been programmed.

FIG. 10B illustrates the read points for reading the lower page in the 1-2-4 coding when the middle page has been programmed but not the upper page.

FIG. 10C illustrates the read points for reading the lower page in the 1-2-4 coding when both the middle and upper pages have been programmed.

FIG. 11A illustrates the read points for reading the middle page in the 1-2-4 coding when the upper page has not been programmed.

FIG. 11B illustrates the read points for reading the middle page in the 1-2-4 coding when the upper page has been programmed.

FIG. 12 illustrates the read points for reading the upper page in the 1-2-4 coding. The read points are at “A”, “C”, “E” and “G”.

FIG. 13(0) illustrates a “2-3-2” coding that supports invariant read points.

FIG. 13(1) illustrates the lower page programming of a memory with 2-3-2 coding.

FIG. 13(2) illustrates the middle page programming of a memory with 2-3-2 coding.

FIG. 13(3) illustrates the upper page programming of a memory with 2-3-2 coding.

FIG. 14(0) illustrates a “2-3-2” coding that supports invariant read points.

FIG. 14(1) illustrates reading the lower page of the memory with 2-3-2 coding in the case when the lower page has been programmed but not the middle and upper pages.

FIG. 14(2) illustrates reading the lower page of the memory with 2-3-2 coding in the case when the lower and middle pages have been programmed but not the upper page.

FIG. 14(3) illustrates reading the lower page of the memory with 2-3-2 coding in the case when the lower, middle and upper pages have been programmed.

FIG. 15(0) illustrates a “2-3-2” coding that supports invariant read points.

FIG. 15(1) illustrates reading the middle page of the memory with 2-3-2 coding in the case when the lower page has been programmed but not the middle and upper pages, which is not applicable when the middle page has been programmed.

FIG. 15(2) illustrates reading the middle page of the memory with 2-3-2 coding in the case when the lower and middle pages have been programmed but not the upper page.

FIG. 15(3) illustrates reading the middle page of the memory with 2-3-2 coding in the case when the lower, middle and upper pages have been programmed.

FIG. 16(0) to FIG. 16(3) illustrate reading the upper page of the memory with 2-3-2 coding.

FIG. 17(0) illustrates a “4-2-1” coding that supports invariant read points.

FIG. 17(1) illustrates the lower page programming of a memory with 4-2-1 coding.

FIG. 17(2) illustrates the middle page programming of a memory with 4-2-1 coding.

FIG. 17(3) illustrates the upper page programming of a memory with 4-2-1 coding.

FIG. 18(0) illustrates a “4-2-1” coding that supports invariant read points.

FIG. 18(1) illustrates reading the lower page of the memory with 4-2-1 coding in the case when the lower page has been programmed but not the middle and upper pages.

FIG. 18(2) illustrates reading the lower page of the memory with 4-2-1 coding in the case when the lower and middle pages have been programmed but not the upper page.

FIG. 18(3) illustrates reading the lower page of the memory with 4-2-1 coding in the case when the lower, middle and upper pages have been programmed.

FIG. 19(0) illustrates a “4-2-1” coding that supports invariant read points.

FIG. 19(1) illustrates reading the middle page of the memory with 4-2-1 coding in the case when the lower page has been programmed but not the middle and upper pages, which is not applicable when the middle page has been programmed.

FIG. 19(2) illustrates reading the middle page of the memory with 4-2-1 coding in the case when the lower and middle pages have been programmed but not the upper page.

FIG. 19(3) illustrates reading the middle page of the memory with 4-2-1 coding in the case when the lower, middle and upper pages have been programmed.

FIG. 20(0) to FIG. 20(3) illustrate reading the upper page of the memory with 4-2-1 coding.

FIG. 21(0) illustrates a “2-1-4” coding that supports invariant read points.

FIG. 21(1) illustrates the lower page programming of a memory with 2-1-4 coding.

FIG. 21(2) illustrates the middle page programming of a memory with 2-1-4 coding.

FIG. 21(3) illustrates the upper page programming of a memory with 2-1-4 coding.

FIG. 22(0) illustrates a “2-1-4” coding that supports invariant read points.

FIG. 22(1) illustrates reading the lower page of the memory with 2-1-4 coding in the case when the lower page has been programmed but not the middle and upper pages.

FIG. 22(2) illustrates reading the lower page of the memory with 2-1-4 coding in the case when the lower and middle pages have been programmed but not the upper page.

FIG. 22(3) illustrates reading the lower page of the memory with 2-1-4 coding in the case when the lower, middle and upper pages have been programmed.

FIG. 23(0) illustrates a “2-1-4” coding that supports invariant read points.

FIG. 23(1) illustrates the case when the lower page has been programmed but not the middle and upper pages, which is not applicable when the middle page has been programmed.

FIG. 23(2) illustrates reading the middle page of the memory with 2-1-4 coding in the case when the lower and middle pages have been programmed but not the upper page.

FIG. 23(3) illustrates reading the middle page of the memory with 2-1-4 coding in the case when the lower, middle and upper pages have been programmed.

FIG. 24(0) to FIG. 24(3) illustrates reading the upper page of the memory with 2-1-4 coding.

### DETAILED DESCRIPTION

### Memory System

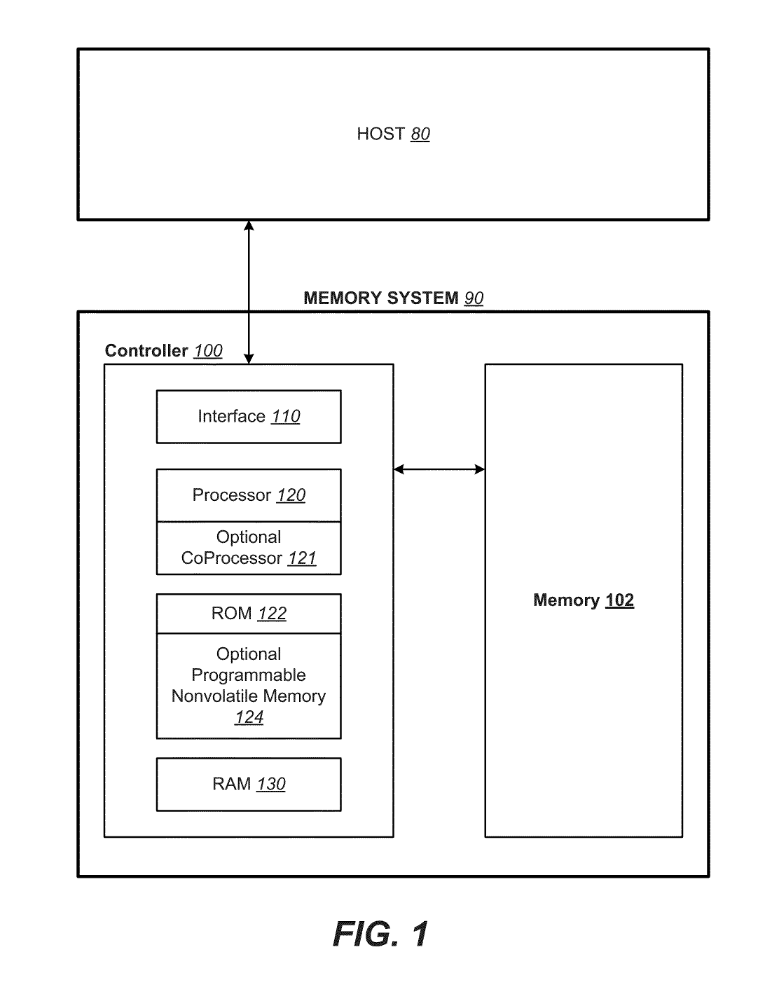

FIG. 1 illustrates schematically the main hardware components of a memory system suitable for implementing the present subject matter. The memory system 90 typically operates with a host 80 through a host interface. The memory system may be in the form of a removable memory such as a memory card, or may be in the form of an embedded memory system. The memory system 90 includes a memory 102 whose operations are controlled by a controller 100. The memory 102 comprises one or more array of non-volatile memory cells distributed over one or more integrated circuit chip. The controller 100 may include interface circuits 110, a processor 120, ROM (read-only-memory) 122, RAM (random access memory) 130, programmable nonvolatile memory 124, and additional components. The controller is typically formed as an ASIC (application specific integrated circuit) and the components included in such an ASIC generally depend on the particular application.

With respect to the memory section 102, semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

It will be recognized that the following is not limited to the two dimensional and three dimensional exemplary structures described but cover all relevant memory structures within the spirit and scope as described herein

### Physical Memory Structure

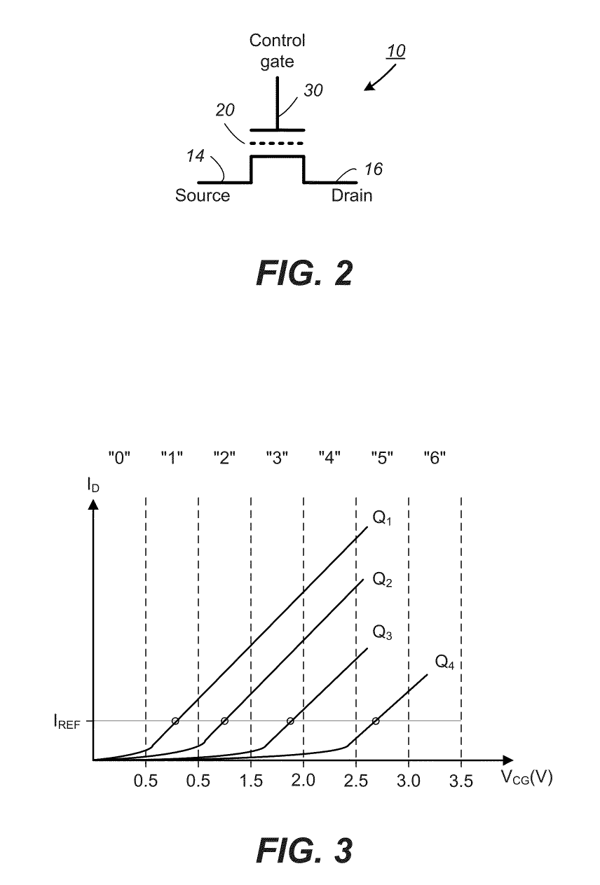

FIG. 2 illustrates schematically a non-volatile memory cell. The memory cell 10 can be implemented by a field-effect transistor having a charge storage unit 20, such as a floating gate or a charge trapping (dielectric) layer. The memory cell 10 also includes a source 14, a drain 16, and a control gate 30.

There are many commercially successful non-volatile solid-state memory devices being used today. These memory devices may employ different types of memory cells, each type having one or more charge storage element.

Typical non-volatile memory cells include EEPROM and flash EEPROM. Also, examples of memory devices utilizing dielectric storage elements.

In practice, the memory state of a cell is usually read by sensing the conduction current across the source and drain electrodes of the cell when a reference voltage is applied to the control gate. Thus, for each given charge on the floating gate of a cell, a corresponding conduction current with respect to a fixed reference control gate voltage may be detected. Similarly, the range of charge programmable onto the floating gate defines a corresponding threshold voltage window or a corresponding conduction current window.

Alternatively, instead of detecting the conduction current among a partitioned current window, it is possible to set the threshold voltage for a given memory state under test at the control gate and detect if the conduction current is lower or higher than a threshold current (cell-read reference current). In one implementation the detection of the conduction current relative to a threshold current is accomplished by examining the rate the conduction current is discharging through the capacitance of the bit line.

FIG. 3 illustrates the relation between the source-drain current I_{D} and the control gate voltage V_{CG} for four different charges Q1-Q4 that the floating gate may be selectively storing at any one time. With fixed drain voltage bias, the four solid I_{D} versus V_{CG} curves represent four of seven possible charge levels that can be programmed on a floating gate of a memory cell, respectively corresponding to four possible memory states. As an example, the threshold voltage window of a population of cells may range from 0.5V to 3.5V. Seven possible programmed memory states “0”, “1”, “2”, “3”, “4”, “5”, “6”, and an erased state (not shown) may be demarcated by partitioning the threshold window into regions in intervals of 0.5V each. For example, if a reference current, IREF of 2 μA is used as shown, then the cell programmed with Q1 may be considered to be in a memory state “1” since its curve intersects with I_{REF} in the region of the threshold window demarcated by VCG=0.5V and 1.0V. Similarly, Q4 is in a memory state “5”.

As can be seen from the description above, the more states a memory cell is made to store, the more finely divided is its threshold window. For example, a memory device may have memory cells having a threshold window that ranges from −1.5V to 5V. This provides a maximum width of 6.5V. If the memory cell is to store 16 states, each state may occupy from 200 mV to 300 mV in the threshold window. This will require higher precision in programming and reading operations in order to be able to achieve the required resolution.

### NAND Structure

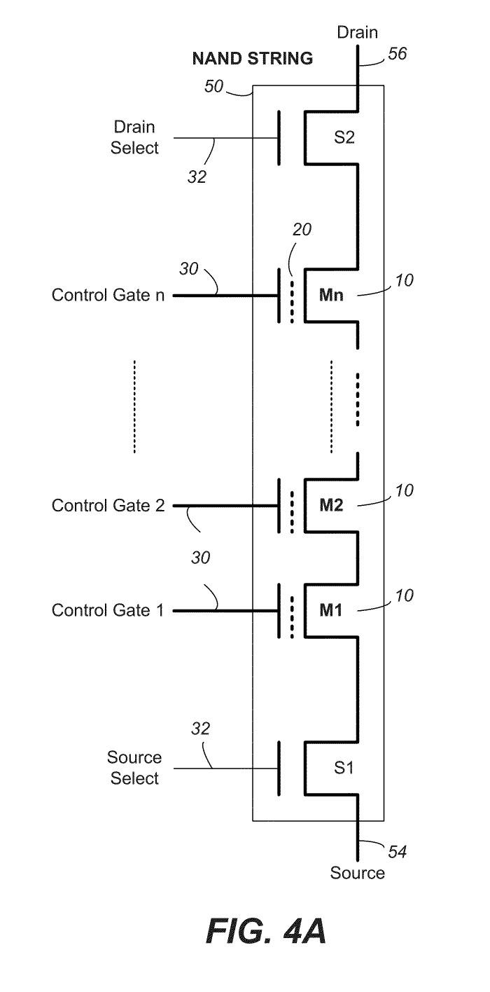

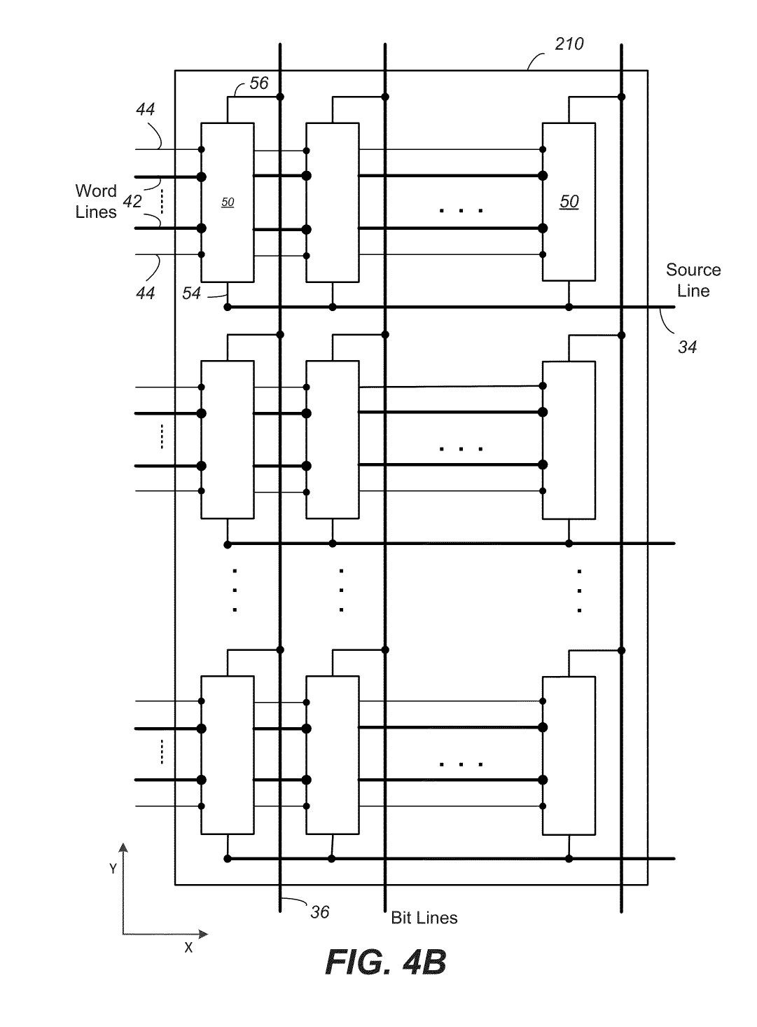

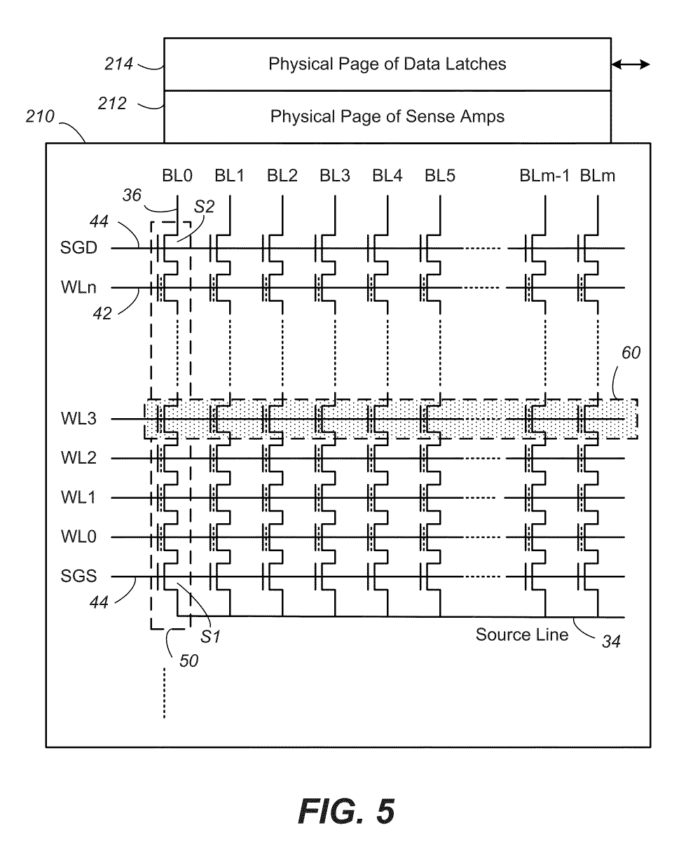

FIG. 4A illustrates schematically a string of memory cells organized into a NAND string. A NAND string 50 comprises a series of memory transistors M1, M2, . . . Mn (e.g., n=4, 8, 16 or higher) daisy-chained by their sources and drains. A pair of select transistors S1, S2 controls the memory transistor chain's connection to the external world via the NAND string's source terminal 54 and drain terminal 56 respectively. In a memory array, when the source select transistor 51 is turned on, the source terminal is coupled to a source line (see FIG. 5). Similarly, when the drain select transistor S2 is turned on, the drain terminal of the NAND string is coupled to a bit line of the memory array. Each memory transistor 10 in the chain acts as a memory cell. It has a charge storage element 20 to store a given amount of charge so as to represent an intended memory state. A control gate 30 of each memory transistor allows control over read and write operations. As will be seen in FIG. 5, the control gates 30 of corresponding memory transistors of a row of NAND string are all connected to the same word line. Similarly, a control gate 32 of each of the select transistors S1, S2 provides control access to the NAND string via its source terminal 54 and drain terminal 56 respectively. Likewise, the control gates 32 of corresponding select transistors of a row of NAND string are all connected to the same select line.

When an addressed memory transistor 10 within a NAND string is read or is verified during programming, its control gate 30 is supplied with an appropriate voltage. At the same time, the rest of the non-addressed memory transistors in the NAND string 50 are fully turned on by application of sufficient voltage on their control gates. In this way, a conductive path is effectively created from the source of the individual memory transistor to the source terminal 54 of the NAND string and likewise for the drain of the individual memory transistor to the drain terminal 56 of the cell.

FIG. 4B illustrates an example of a NAND array 210 of memory cells, constituted from NAND strings 50 such as that shown in FIG. 4A. Along each column of NAND strings, a bit line such as bit line 36 is coupled to the drain terminal 56 of each NAND string. Along each bank of NAND strings, a source line such as source line 34 is coupled to the source terminals 54 of each NAND string. Also the control gates along a row of memory cells in a bank of NAND strings are connected to a word line such as word line 42. The control gates along a row of select transistors in a bank of NAND strings are connected to a select line such as select line 44. An entire row of memory cells in a bank of NAND strings can be addressed by appropriate voltages on the word lines and select lines of the bank of NAND strings.

FIG. 5 illustrates a page of memory cells, organized in the NAND configuration, being sensed or programmed in parallel. FIG. 5 essentially shows a bank of NAND strings 50 in the memory array 210 of FIG. 4B, where the detail of each NAND string is shown explicitly as in FIG. 4A. A physical page, such as the page 60, is a group of memory cells enabled to be sensed or programmed in parallel. This is accomplished by a corresponding page of sense amplifiers 212. The sensed results are latched in a corresponding set of latches 214. Each sense amplifier can be coupled to a NAND string via a bit line. The page is enabled by the control gates of the cells of the page connected in common to a word line 42 and each cell accessible by a sense amplifier accessible via a bit line 36. As an example, when respectively sensing or programming the page of cells 60, a sensing voltage or a programming voltage is respectively applied to the common word line WL3 together with appropriate voltages on the bit lines. A chip-level control circuitry 220 has a state machine 222 that controls the memory operations.

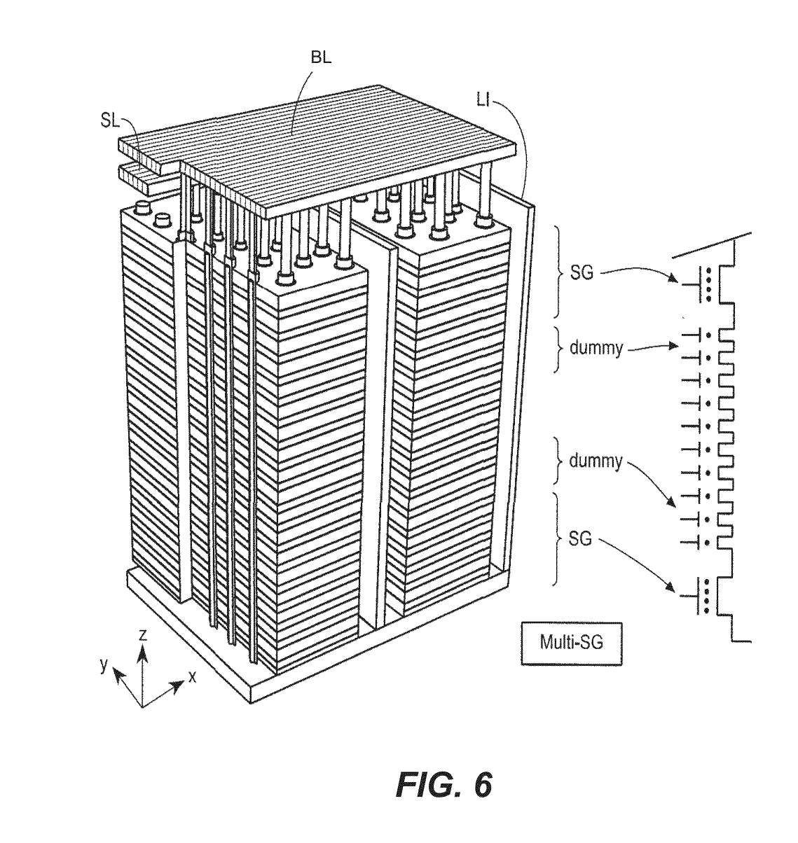

FIG. 6 illustrates an oblique projection of a part of a 3D NAND memory. An alternative arrangement to a two-dimensional (2-D) NAND array is a three-dimensional (3-D) array. In contrast to 2-D NAND arrays, which are formed along a planar surface of a semiconductor wafer, 3-D arrays extend up from the wafer surface and generally include stacks, or columns, of memory cells extending upwards. Various 3-D arrangements are possible. In one arrangement a NAND string is formed vertically with one end (e.g. source) at the wafer surface and the other end (e.g. drain) on top. In another arrangement a NAND string is formed in a U-shape so that both ends of the NAND string are accessible on top, thus facilitating connections between such strings.

### Physical Organization of the Memory

One difference between flash memory and other of types of memory is that a cell is programmed from the erased state. That is, the floating gate is first emptied of charge. Programming then adds a desired amount of charge back to the floating gate. It does not support removing a portion of the charge from the floating gate to go from a more programmed state to a lesser one. This means that updated data cannot overwrite existing data and is written to a previous unwritten location.

Furthermore erasing is to empty all the charges from the floating gate and generally takes appreciable time. For that reason, it will be cumbersome and very slow to erase cell by cell or even page by page. In practice, the array of memory cells is divided into a large number of blocks of memory cells. As is common for flash EEPROM systems, the block is the unit of erase. That is, each block contains the minimum number of memory cells that are erased together. While aggregating a large number of cells in a block to be erased in parallel will improve erase performance, a large size block also entails dealing with a larger number of update and obsolete data.

Each block is typically divided into a number of physical pages. A logical page is a unit of programming or reading that contains a number of bits equal to the number of cells in a physical page. In a memory that stores one bit per cell, one physical page stores one logical page of data. In memories that store two bits per cell, a physical page stores two logical pages. The number of logical pages stored in a physical page thus reflects the number of bits stored per cell. In one embodiment, the individual pages may be divided into segments and the segments may contain the fewest number of cells that are written at one time as a basic programming operation. One or more logical pages of data are typically stored in one row of memory cells. A page can store one or more sectors. A sector includes user data and overhead data.

Prior Art “LM” “1-2-4” Coding for a 3-bit or 8-state Memory

In order for a single cell to store three bits of information the cell must be able to be in one of eight different states. So a 3-bit TLC (Tri-level) cell should support eight different valid ranges for its threshold voltage.

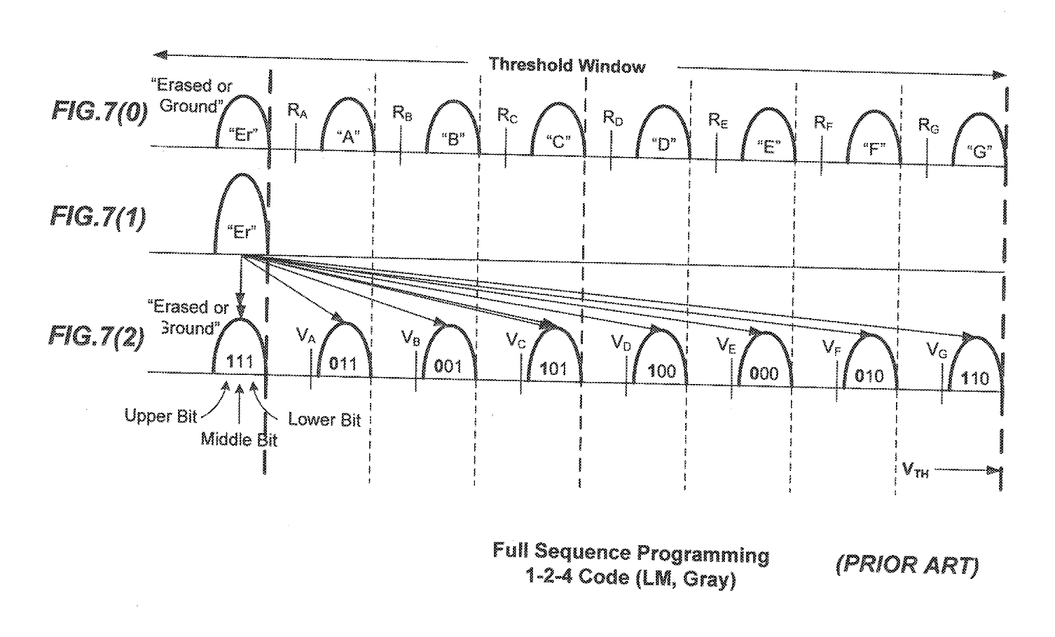

FIG. 7(0) illustrates the threshold voltage distributions of an 8-state memory array. The possible threshold voltages of each memory cell spans a threshold window which is partitioned into eight regions to demarcate eight possible memory states, {Gr}, {A}, {B}, {C}, {D}, {E}, {F} and {G}. {Gr} is a ground state, which is an erased state within a tightened distribution and {A}-{G} are seven progressively programmed states. During read, the eight states are demarcated by seven demarcation breakpoints, D_{A}-D_{G}.

### Full Sequence Programming and Read

FIG. 7(1) and FIG. 7(2) illustrate a full-sequence programming in which all three bits of the 8-state memory are programming at the same time.

FIG. 7(1) illustrates that prior to programming a population of memory cells, the memory cells are in an erase state.

FIG. 7(2) illustrates that in a full-sequence programming, each of the memory states are programmed directly from the erased state.

FIG. 7(2) also illustrates an existing 3-bit LM coding used to represent the eight possible memory states shown in FIG. 7(0). Each of the eight memory states is represented by a triplet of “upper, middle, lower” bits, namely “111”, “011”, “001”, “101”, “100”, “000”, “010” and “110” respectively. The coding is designed such that the 3 code bits, “lower”, “middle” and “upper” bits, may be programmed and read separately. Thus, the first round, lower page programming has a cell remain in the “erased” or “Gr” state if the lower bit is “1” or programmed to a “lower intermediate” state if the lower bit is “0”. Basically, the “Gr” or “ground” state is the “erased” state with a tightened distribution by having the deeply erased states programmed to within a narrow range of threshold values. The “lower intermediate” states may have a broad distribution of threshold voltages that straddling between memory states “B” and “D”. During programming, the “lower intermediate” state can be verified relative to a coarse breakpoint threshold level such as D_{B}. When programming the middle bit, the threshold level of a cell will start from one of the two regions resulted from the lower page programming and move to one of four possible regions. When programming the upper bit, the threshold level of a cell will start from one of the four possible regions resulted from the middle page programming and move to one of eight possible memory states.

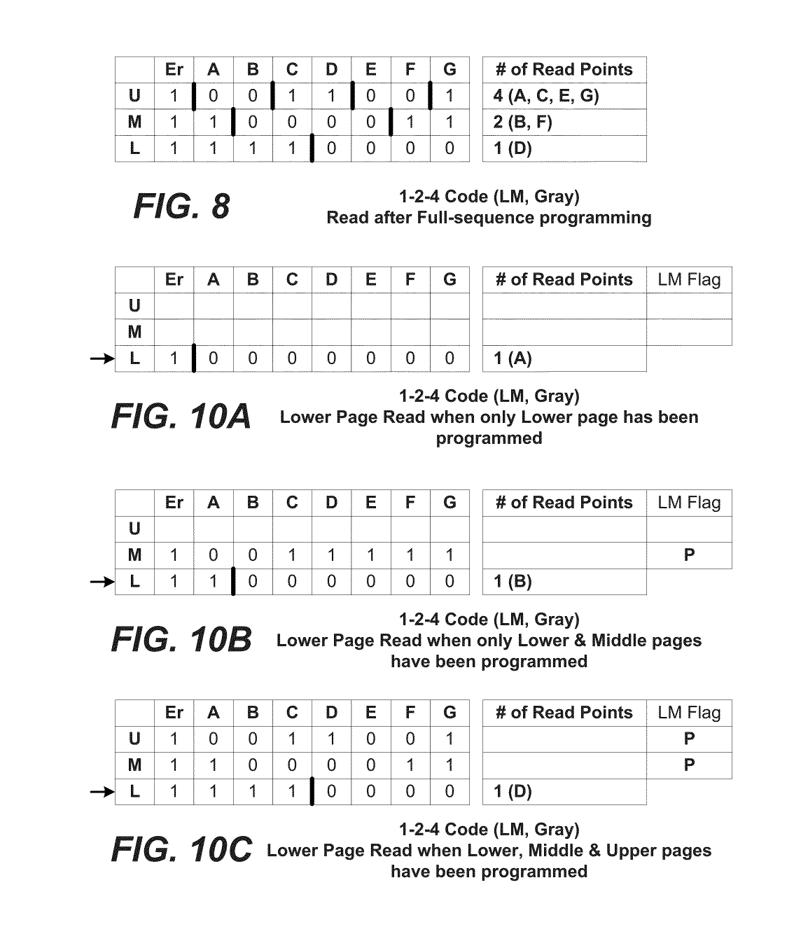

FIG. 8 illustrates the read points for each of the data pages with the 1-2-4 coding after a full-sequence programming. The “1-2-4” refers to the number of read points for the lower, middle and upper page respectively. To distinguish the “1” from the “0” bit, each of the pages must be read relative to a set of read points. The lower page only needs one read point at “D”. The read data is “1” if the read state is below state “D”. The read data is “0” if the read state is at stated” or above. The middle page needs two read points at “B” and “F”. The read data is “1” if the read state is below state “B” or at “F” and above. The read data is “0” if the read state is between “B” and “F”. The upper page needs three read points at “A”, “C”, “E” and “G”. The read data is “1” if the read state is below state “A” or between “C” and “D” or at “G” and above. The read data is “0” if the read state is between “A” and “B” or between “E” and

### Page-by-Page Programming and Read

The full sequence programming of the 3-bit memory described in connection with FIG. 7(1) and FIG. 7(2) has all three data pages programmed together. Similar, the individual data pages cannot be read until all three pages have been programmed.

It is also common, in MLC flash memories that assign a cell's bits to different data pages, to have a lower bit in a lower-numbered page and to require the user to write the pages in sequential order so that a lower-numbered page is written before a higher order page. This method of writing is called page-by-page programming.

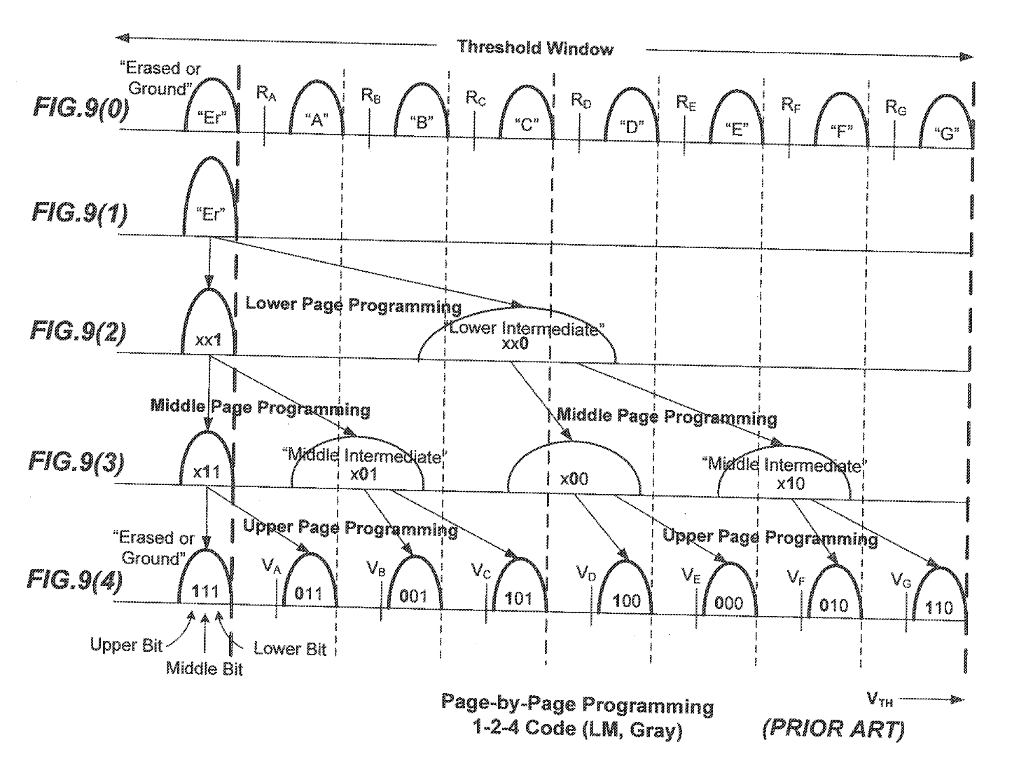

FIG. 9(0) to FIG. 9(4) illustrate page-by-page programming and read for the 1-2-4 coding described in connection with FIG. 7(0) and FIG. 7(1).

FIG. 9(0) illustrates the threshold voltage distributions of an 8-state memory array, similar to FIG. 7(0). The eight memory states are identified in order of increasing threshold values as “Er”, “A”, “B”, “C”, “D”, “E”, “F” and “G”. These memory states are distinguished by the read points R_{A}, R_{B}, R_{C}, R_{D}, R_{E}, R_{F} and R_{G} respectively.

FIG. 9(1) illustrates that the population of memory cells to be programmed are initially at an erased state.

FIG. 9(2) illustrates the lower page programming with the 1-2-4 coding in which all memory cells having target states with “xx1” remain unprogrammed in the erased state (with x=“1” or “0”). This means all the memory cells having target states as “Er”, “A”, “B” and “C” are not programmed. On the other hand, all the memory cells having target states with “xx0”, i.e., “D”, “E”, “F” and “G” are programmed to an area in a “lower intermediate” portion of the threshold window. The lower intermediate portion has thresholds less than or equal to “D”.

FIG. 9(3) illustrates the middle page programming with the 1-2-4 coding in which all memory cells having target states with “x11” remain unprogrammed in the erased state (with x=“1” or “0”). This means all the memory cells having target states as “Er” and “A” are not programmed. On the other hand, all the memory cells having target states with “x01”, i.e., “B” and “C” are programmed to an area in a “first middle intermediate” portion of the threshold window. The first middle intermediate portion has thresholds less than or equal to “C”.

All the memory cells having target states with “x00”, i.e., “D” and “E” are programmed from the lower intermediate portion of the threshold window to an area in a “second middle intermediate” portion of the threshold window. The second middle intermediate portion has thresholds less than or equal to “D”. On the other hand, all the memory cells having target states with “x10”, i.e., “F” and “G” are programmed from the lower intermediate portion to an area in a “third middle intermediate” portion of the threshold window. The third middle intermediate portion has thresholds less than or equal to “F”.

FIG. 9(4) illustrates the upper page programming in the 1-2-4 coding in which all memory cells are programmed to their respective target states. Thus the states “111”, “011”, “001”, “101”, “100”, “000”, “010” and “110” are respectively programmed to states “Er”, “A”, “B”, “C”, “D”, “E”, “F” and “G”.

It can be seen that page-by page programming allows the lower page to be programmed and read. After the lower page has been programmed, the middle page can then be programmed and read. After the middle page has been programmed, the upper page can then be programmed and read.

However, the 1-2-4 coding does not yield a set of invariant read points for reading a page with lower bit order. FIG. 10A, FIG. 10B and FIG. 10C, respectively show the read point for the lower page depends on whether any combinations of middle and upper pages have been programmed or not.

FIG. 10A illustrates the read points for reading the lower page in the 1-2-4 coding when the middle and upper pages have not been programmed. The read point is at “A”. A read below “A” will result in “1” and a read at or above “A” will result in “0”.

FIG. 10B illustrates the read points for reading the lower page in the 1-2-4 coding when the middle page has been programmed but not the upper page. The read point is at “B”. A read below “B” will result in “1” and a read at or above “B” will result in “0”.

FIG. 10C illustrates the read points for reading the lower page in the 1-2-4 coding when both the middle and upper pages have been programmed. The read point is at “D”. A read below “D” will result in “1” and a read at or above “D” will result in “0”.

An LM flag is maintained to indicate if the middle page has been programmed but not the upper page, or if both the middle and upper pages have been programmed so that the correct read point could be used to read the lower page.

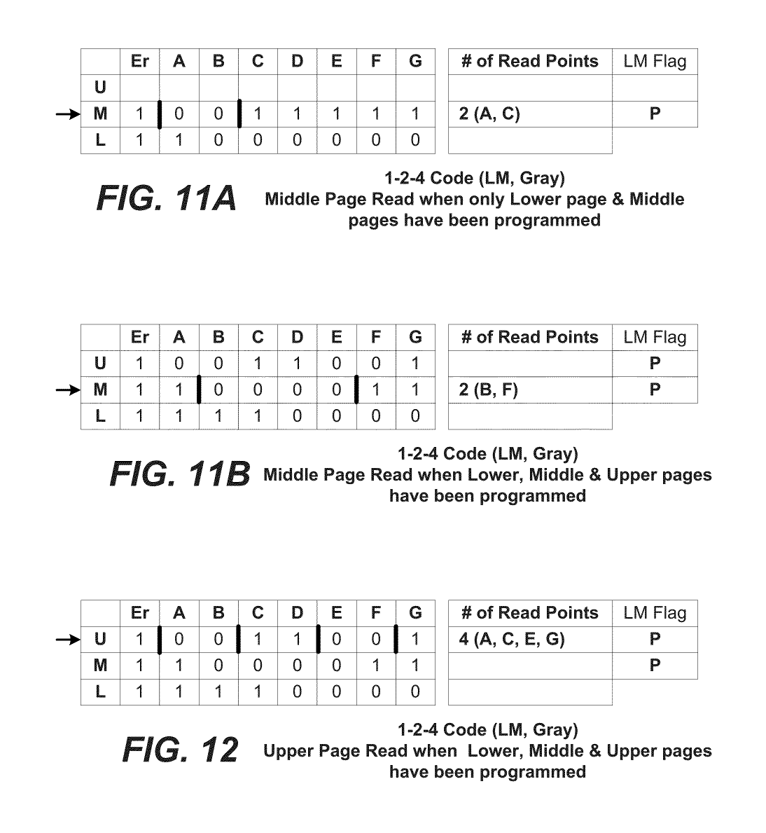

FIG. 11A illustrates the read points for reading the middle page in the 1-2-4 coding when the upper page has not been programmed. The read points are at “A” and “C”. A read below “A” and at or above “C” will result in “1”, otherwise, the read will result in “0”.

FIG. 11B illustrates the read points for reading the middle page in the 1-2-4 coding when the upper page has been programmed. The read points are at “B” and “F”. A read below “B” and at or above “F” will result in “1”, otherwise, the read will result in “0”.

FIG. 12 illustrates the read points for reading the upper page in the 1-2-4 coding. The read points are at “A”, “C”, “E” and “G”. A read below “A” and at or above “C” but below “E” or at or above “G” will result in “1”, otherwise, the read will result in “0”.

Thus, Prior state encodings, such as the 1-2-4 coding described, have to use different sets of read points for a lower data page depending on whether or not the higher order pages are already programmed, as indicated by maintaining a flag.

3-Bit Coding with Predefined Programing order to Support Invariant Read Points

In page-by-page schemes, each data page can be programmed and read independently. Each data page has a set of predetermined read points to distinguish between “1” and “0” bits. The present programming and state encoding schemes yield invariant read points, independent of the program status of the higher order pages and do not require maintaining a flag, thereby improving read performance.

“2-3-2” Coding with Invariant Read Points

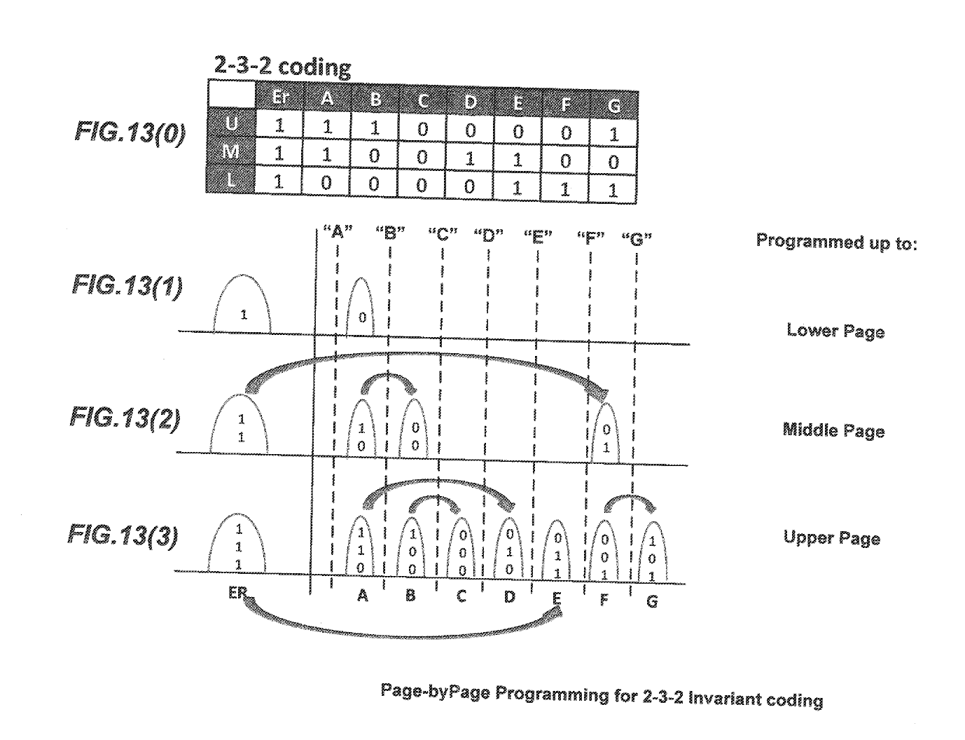

FIG. 13(0) illustrates a “2-3-2” coding that supports invariant read points. This is a Grey code. The 8 states {111, 110, 100, 000, 010, 011, 001 and 101} correspond to states {Er, A, B, C, D, E, F and G} respectively. Similar to FIG. 9(0), the memory states are demarcated by the read points “A”, “B”, “C”, “D”, “E”, “F” and “G”.

FIG. 13(1) to FIG. 13(3) illustrate page-by-page programming for a memory with 2-3-2 coding and having invariant read points. The programming is performed in order of lower, middle and upper pages.

FIG. 13(1) illustrates the lower page programming of a memory with 2-3-2 coding. Initially all three pages are in an erased state. When programming the lower page, the memory cells targeted for {Er, E, F, G} all have the coding as {xx1} and therefore their threshold values will be unchanged and are equal to those of the erased state {Er}. The memory cells targeted for {A, B, C, D} all have the coding as {xx0} and therefore have their threshold values increased to just below that of {A}.

FIG. 13(2) illustrates the middle page programming of a memory with 2-3-2 coding. When programming the middle page subsequent to the lower page having been programmed, the memory cells targeted for {Er, E} both have their coding as {x11} respectively and therefore have their threshold values unchanged and are equal to those of the erased state {Er}. The memory cells targeted for {F, G} both have their coding as {x01} and therefore have their threshold values increased to just below that of {F}, the memory cells targeted for {A, D} both have their coding as {x10} and therefore their threshold values remain unchanged. The memory cells targeted for {B,C} both have their coding as {x00} have their threshold values increased to just below that of {B}.

FIG. 13(3) illustrates the upper page programming of a memory with 2-3-2 coding. When programming the upper page subsequent to the lower and middle pages having been programmed, the memory cells targeted for {Er, A, B, C, D, E, F, G} have their thresholds adjusted to correspond to that of {Er, A, B, C, D, E, F, G}.

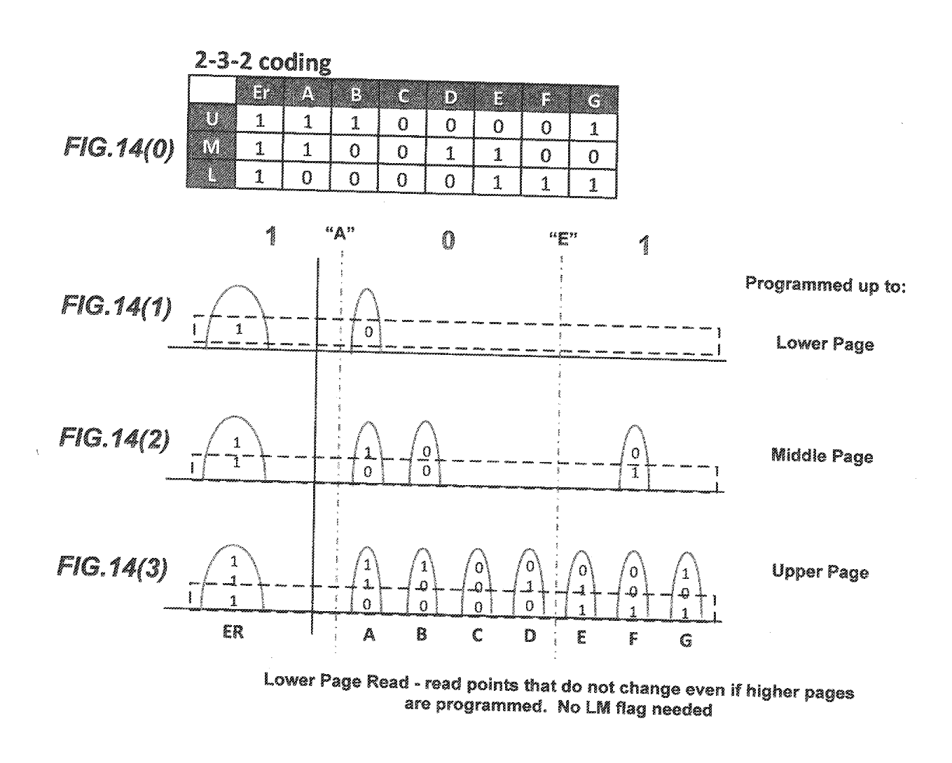

FIG. 14(0) illustrates a “2-3-2” coding that supports invariant read points. FIG. 14(1) to FIG. 14(3) illustrate reading the lower page of the memory with 2-3-2 coding.

FIG. 14(1) illustrates reading the lower page of the memory with 2-3-2 coding in the case when the lower page has been programmed but not the middle and upper pages. FIG. 14(2) illustrates reading the lower page of the memory with 2-3-2 coding in the case when the lower and middle pages have been programmed but not the upper page. FIG. 14(3) illustrates reading the lower page of the memory with 2-3-2 coding in the case when the lower, middle and upper pages have been programmed.

The invariant set of read points for the lower page, irrespective of whether or not the higher order pages have been programmed, is to read at “A” and “E”, with a read data being “1” if the memory cell is read as below “A” or at least “E”, or a read data being “0” if the memory cell is read as at least “A” and below “E”.

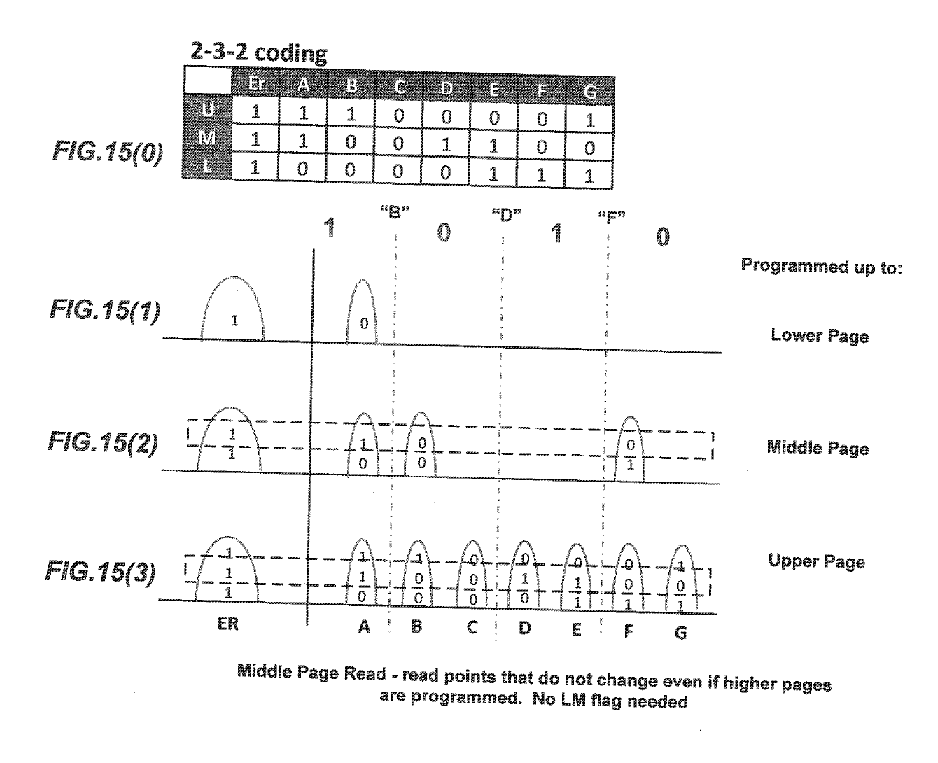

FIG. 15(0) illustrates a “2-3-2” coding that supports invariant read points. FIG. 15(1) to FIG. 15(3) illustrates reading the middle page of the memory with 2-3-2 coding.

FIG. 15(1) illustrates reading the middle page of the memory with 2-3-2 coding in the case when the lower page has been programmed but not the middle and upper pages which is not applicable when the middle page has been programmed.

FIG. 15(2) illustrates reading the middle page of the memory with 2-3-2 coding in the case when the lower and middle pages have been programmed but not the upper page.

FIG. 15(3) illustrates reading the middle page of the memory with 2-3-2 coding in the case when the lower, middle and upper pages have been programmed.

The invariant set of read points for the middle page is to read at “B”, “D” and “F”, with a read data being “1” if the memory cell is read as below “B” or at least “D” and below “F”, or a read data being “0” if the memory cell is read as at least “B” and below “D” or at least “F”.

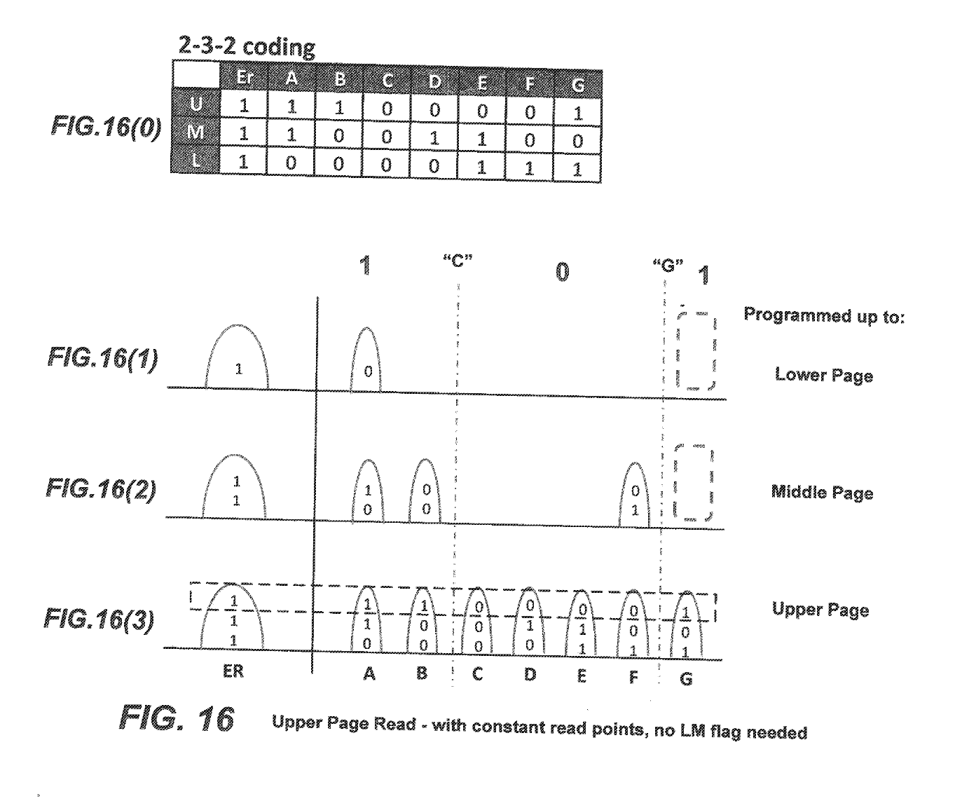

FIG. 16(0) illustrates a “2-3-2” coding that supports invariant read points. FIG. 16(1) to FIG. 16(3) illustrate reading the upper page of the memory with 2-3-2 coding. In particular, FIG. 16(3) illustrates reading the upper page of the memory with 2-3-2 coding in the case when the lower, middle and upper pages have been programmed.

The invariant set of read points for the upper page is to read at “C” and “G”, with a read data being “1” if the memory cell is read as below “C” or at least memory state G, or a read data being “0” if the memory cell is at least “C” and below “G”.

“4-2-1” Coding with Invariant Read Points

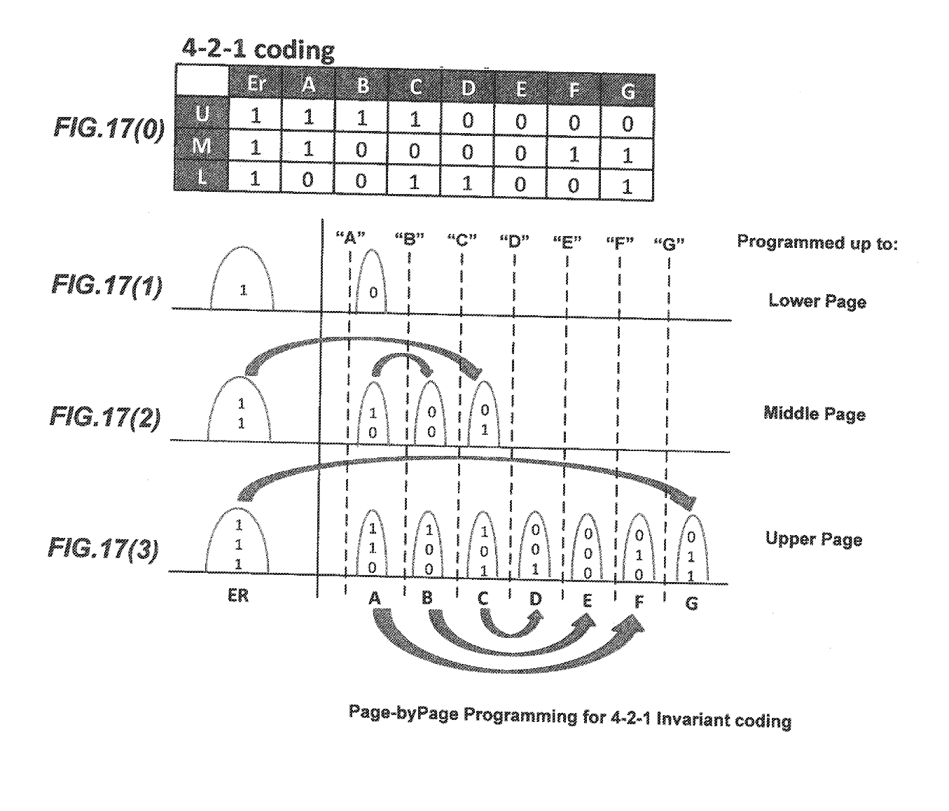

FIG. 17(0) illustrates a “4-2-1” coding that supports invariant read points. This is a Grey code. The 8 states {111, 110, 100, 010, 001, 000, 010 and 011} correspond to states {Er, A, B, C, D, E, F and G} respectively. Similar to FIG. 9(0), the memory states are demarcated by the read points “A”, “B”, “C”, “D”, “E”, “F” and “G”.

FIG. 17(1) to FIG. 17(3) illustrate page-by-page programming for a memory with 2-3-2 coding and having invariant read points. The programming is performed in order of lower, middle and upper pages.

FIG. 17(1) illustrates the lower page programming of a memory with 4-2-1 coding. Initially all three pages are in an erased state. When programming the lower page, the memory cells targeted for {Er, C, D, G} all have the coding as {xxl} and therefore their threshold values will be unchanged and are equal to those of the erased state {Er}. The memory cells targeted for {A, B, E, F} all have the coding as {xx0} and therefore have their threshold values increased to just below that of {A}.

FIG. 17(2) illustrates the middle page programming of a memory with 4-2-1 coding. When programming the middle page subsequent to the lower page having been programmed, the memory cells targeted for {Er, G} both have their coding as {x11} respectively and therefore have their threshold values unchanged and are equal to those of the erased state {Er}. The memory cells targeted for {A, F} both have their coding as {x01} and therefore have their threshold values increased to just below that of {A}, the memory cells targeted for {B, E} both have their coding as {x00} and therefore their threshold values remain unchanged. The memory cells targeted for {C, D} both have their coding as {x01} have their threshold values increased to just below that of {C}.

FIG. 17(3) illustrates the upper page programming of a memory with 4-2-1 coding. When programming the upper page subsequent to the lower and middle pages having been programmed, the memory cells targeted for {Er, A, B, C, D, E, F, G} have their thresholds adjusted to correspond to that of {Er, A, B, C, D, E, F, G}.

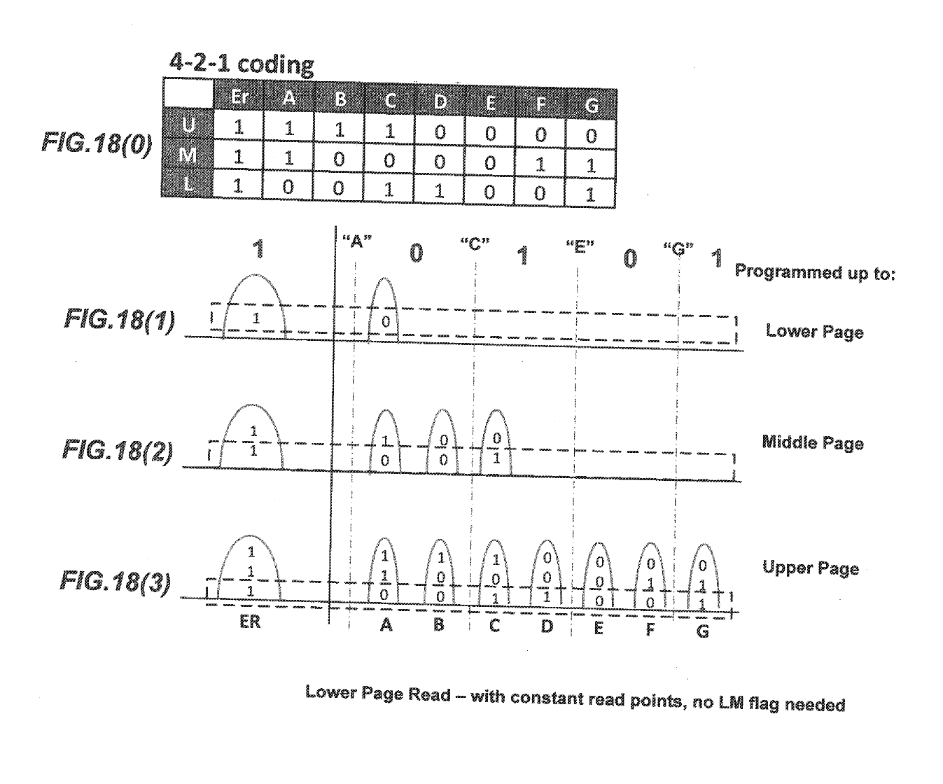

FIG. 18(0) illustrates a “4-2-1” coding that supports invariant read points. FIG. 18(1) to FIG. 18(3) illustrate reading the lower page of the memory with 4-2-1 coding.

FIG. 18(1) illustrates reading the lower page of the memory with 4-2-1 coding in the case when the lower page has been programmed but not the middle and upper pages.

FIG. 18(2) illustrates reading the lower page of the memory with 4-2-1 coding in the case when the lower and middle pages have been programmed but not the upper page.

FIG. 18(3) illustrates reading the lower page of the memory with 4-2-1 coding in the case when the lower, middle and upper pages have been programmed.

The invariant set of read points for the lower page, irrespective of whether or not the higher order pages have been programmed, is to read at “A”, “C”, “E” and “G”, with a read data being “1” if the memory cell is read as below “A” or at least “C” and below “E”, or at least “G”, or a read data being “0” if the memory cell is read as at least “A” and below “C” or at least E and below “G”.

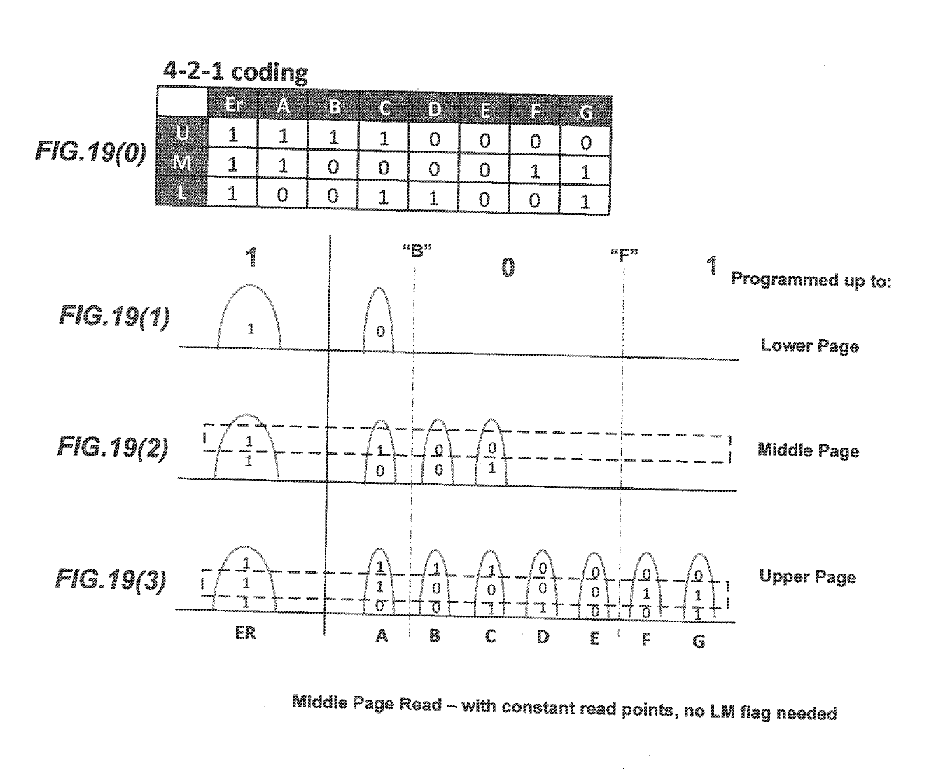

FIG. 19(0) illustrates a “4-2-1” coding that supports invariant read points. FIG. 19(1) to FIG. 19(3) illustrate reading the middle page of the memory with 4-2-1 coding.

FIG. 19(1) illustrates reading the middle page of the memory with 4-2-1 coding in the case when the lower page has been programmed but not the middle and upper pages, which is not applicable when the middle page has been programmed. FIG. 19(2) illustrates reading the middle page of the memory with 4-2-1 coding in the case when the lower and middle pages have been programmed but not the upper page. FIG. 19(3) illustrates reading the middle page of the memory with 4-2-1 coding in the case when the lower, middle and upper pages have been programmed.

The invariant set of read points for the middle page is to read at “B” and “F”, with a read data being “1” if the memory cell is read as below “B” or at least “F”, or a read data being “0” if the memory cell is read as at least “B” and below “F”.

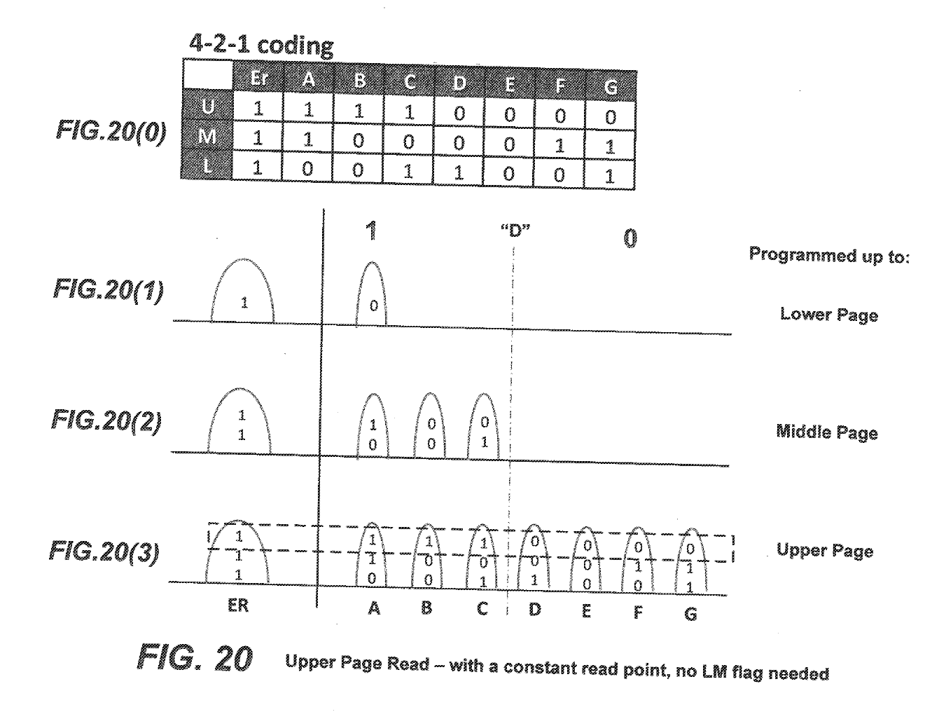

FIG. 20(0) illustrates a “4-2-1” coding that supports invariant read points. FIG. 20(1) to FIG. 20(3) illustrate reading the upper page of the memory with 4-2-1 coding. In particular, FIG. 20(3) illustrates reading the upper page of the memory with 2-3-2 coding in the case when the lower, middle and upper pages have been programmed.

The invariant set of read points for the upper page is to read at “D”, with a read data being “1” if the memory cell is read as below “D”, or a read data being “0” if the memory cell is at least “D”.

“2-1-4” Coding with Invariant Read Points

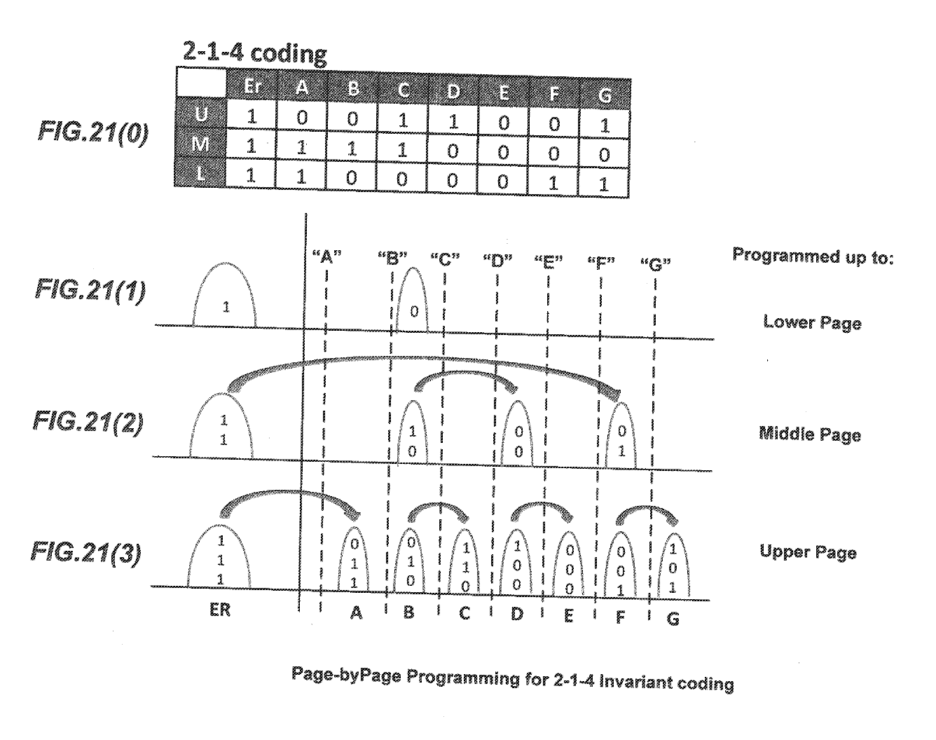

FIG. 21(0) illustrates a “2-1-4” coding that supports invariant read points. This is a Grey code. The 8 states {111, 110, 100, 000, 010, 011, 001 and 101} correspond to states {Er, A, B, C, D, E, F and G} respectively. Similar to FIG. 9(0), the memory states are demarcated by the read points “A”, “B”, “C”, “D”, “E”, “F” and “G”.

FIG. 21(1) to FIG. 21(3) illustrate page-by-page programming for a memory with 2-1-4 coding and having invariant read points. The programming is performed in order of lower, middle and upper pages.

FIG. 21(1) illustrates the lower page programming of a memory with 2-1-4 coding. Initially all three pages are in an erased state. When programming the lower page, the memory cells targeted for {Er, A, F, G} all have the coding as {xx1} and therefore their threshold values will be unchanged and are equal to those of the erased state {Er}. The memory cells targeted for {B, C, D, E} all have the coding as {xx0} and therefore have their threshold values increased to just below that of {A}.

FIG. 21(2) illustrates the middle page programming of a memory with 2-1-4 coding. When programming the middle page subsequent to the lower page having been programmed, the memory cells targeted for {Er, A} both have their coding as {x11} respectively and therefore have their threshold values unchanged and are equal to those of the erased state {Er}. The memory cells targeted for {F, G} both have their coding as {x01} and therefore have their threshold values increased to just below that of {F}, the memory cells targeted for {B, C} both have their coding as {x10} and therefore their threshold values remain unchanged. The memory cells targeted for {D, E} both have their coding as {x00} have their threshold values increased to just below that of {D}.

FIG. 21(3) illustrates the upper page programming of a memory with 2-1-4 coding. When programming the upper page subsequent to the lower and middle pages having been programmed, the memory cells targeted for {Er, A, B, C, D, E, F, G} have their thresholds adjusted to correspond to that of {Er, A, B, C, D, E, F, G}.

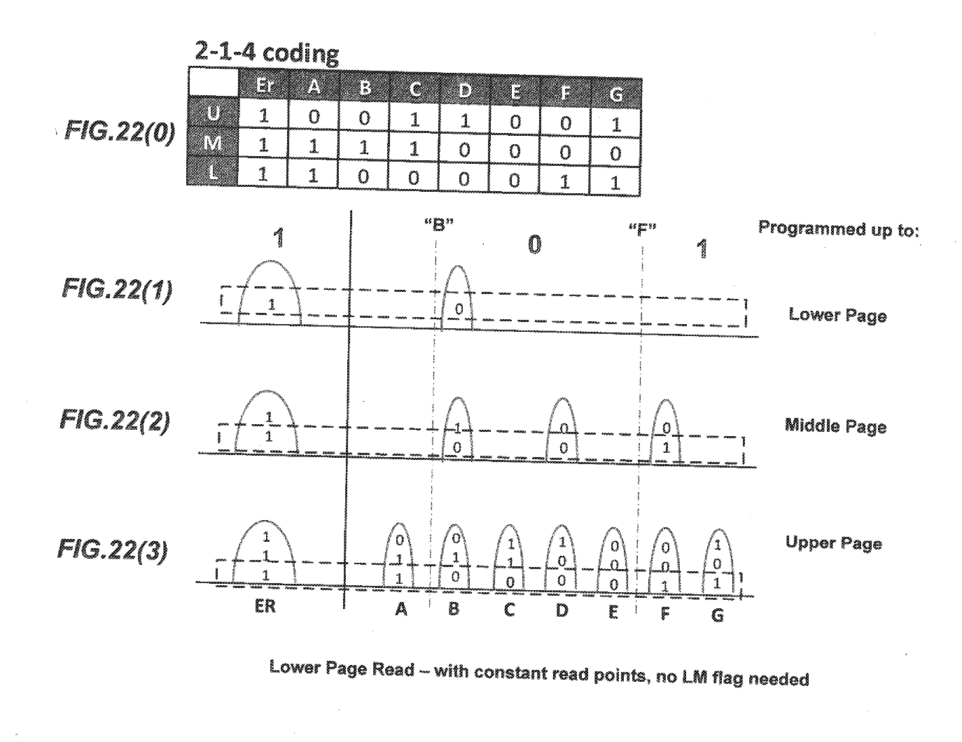

FIG. 22(0) illustrates a “2-1-4” coding that supports invariant read points. FIG. 22(1) to FIG. 22(3) illustrate reading the lower page of the memory with 2-1-4 coding.

FIG. 22(1) illustrates reading the lower page of the memory with 2-1-4 coding in the case when the lower page has been programmed but not the middle and upper pages.

FIG. 22(2) illustrates reading the lower page of the memory with 2-1-4 coding in the case when the lower and middle pages have been programmed but not the upper page.

FIG. 22(3) illustrates reading the lower page of the memory with 2-1-4 coding in the case when the lower, middle and upper pages have been programmed.

The invariant set of read points for the lower page, irrespective of whether or not the higher order pages have been programmed, is to read at “B” and “F”, with a read data being “1” if the memory cell is read as below “B” or at least “F”, or a read data being “0” if the memory cell is read as at least “B” and below “F”.

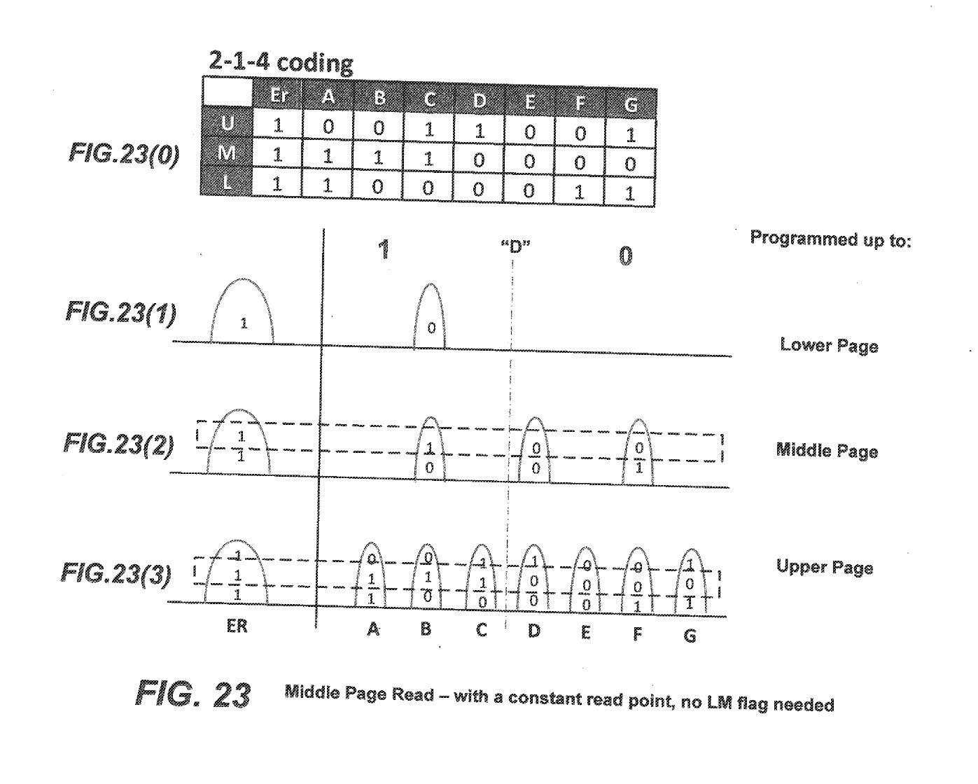

FIG. 23(0) illustrates a “2-1-4” coding that supports invariant read points. FIG. 23(1) to FIG. 23(3) illustrate reading the middle page of the memory with 2-1-4 coding.

FIG. 23(1) illustrates the case when the lower page has been programmed but not the middle and upper pages, which is not applicable when the middle page has been programmed.

FIG. 23(2) illustrates reading the middle page of the memory with 2-1-4 coding in the case when the lower and middle pages have been programmed but not the upper page.

FIG. 23(3) illustrates reading the middle page of the memory with 2-1-4 coding in the case when the lower, middle and upper pages have been programmed.

The invariant set of read points for the middle page is to read at “D”, with a read data being “1” if the memory cell is read as below “D”, or a read data being “0” if the memory cell is read as at least “D”.

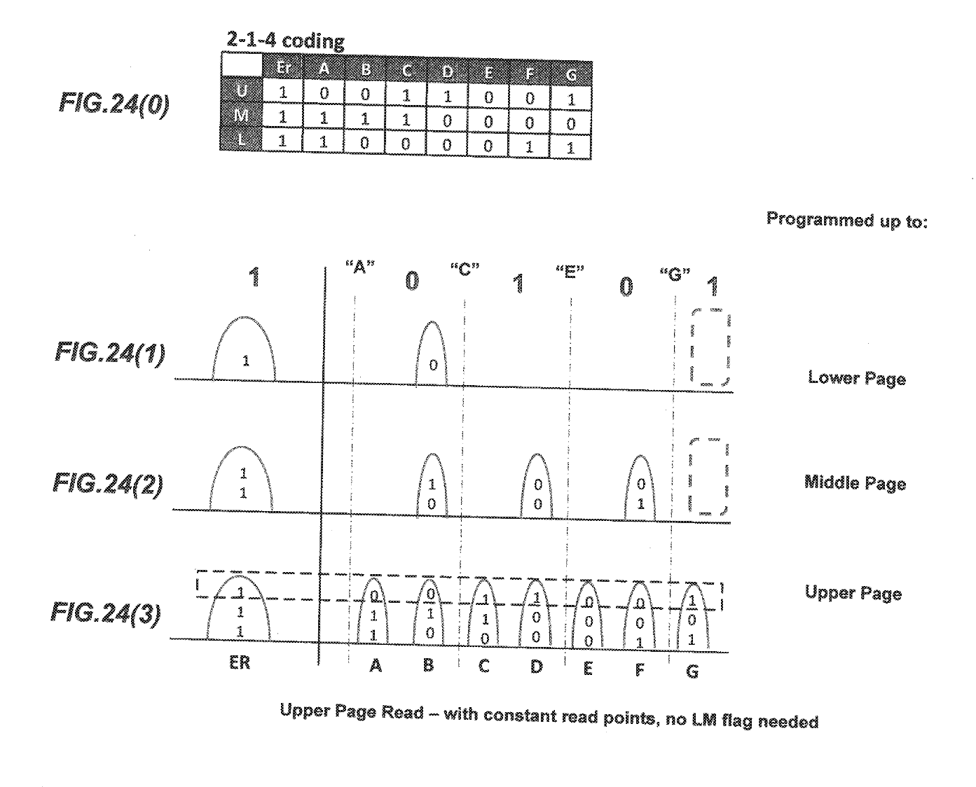

FIG. 24(0) illustrates a “2-1-4” coding that supports invariant read points. FIG. 24(1) to FIG. 24(3) illustrate reading the upper page of the memory with 2-1-4 coding. In particular, FIG. 24(3) illustrates reading the upper page of the memory with 2-3-2 coding in the case when the lower, middle and upper pages have been programmed.

The invariant set of read points for the upper page is to read at “A”, “C”, “E” and “G”, with a read data being “1” if the memory cell is read as below “A” or at least “C” and below “E” or at least “G”, or a read data being “0” if the memory cell is at least “A” and below “C” or at least “E” and below “G”.

The advantage of page-by-page operation on a physical page of memory cells is that for multi-level cells such that those that store three bit per memory cell, it is more flexible to be able to use the page of memory cells when not all order of data pages have been programmed. Thus, it is possible to immediately use a lower page even when the middle and upper pages are not yet programmed. However, when reading page-by-page, prior encodings and programming schemes yield sets of read points that are dependent on the program status of the higher order pages. An LM flag indicating such status needs to be maintained to enable the correct set of read points. This would require additional reads to retrieve the LM flag.

The advantage of the present flash memory and scheme is that the set of read points are independent of the program status of the higher order pages. Thus, no LM flag is needed. Furthermore the encodings with invariant read points.

### Conclusion

The foregoing detailed description has been presented for purposes of illustration and description. It is not intended to be exhaustive or to limit the above to the precise form disclosed. Many modifications and variations are possible in light of the above teaching. The described embodiments were chosen in order to explain the principles involved and its practical application, to thereby enable others to best utilize the various embodiments and with various modifications as are suited to the particular use contemplated. It is intended that the scope be defined by the claims appended hereto.

It is claimed:

1. A non-volatile memory, comprising:
an array of memory cells, wherein individual memory cells are each in one of eight memory states, the eight memory states being an erase state and seven programmed states with increasing threshold values across a threshold window;
a group of data latches for storing each bit of a 3-bit code word for each memory cell among a group of memory cells operating in parallel, the 3-bit code word being one of eight 3-bit code words generated from a 3-bit code to encode the eight memory states;
the 3-bit code being constituted from a lower bit, a middle bit and an upper bit, wherein a lower page, middle page and upper page of data are respectively constituted from the lower bit, middle bit and upper bit of each memory cell among the group;
read circuits for reading page by page, the lower, middle or upper pages each being read by reference to a respective set of read points of predetermined threshold values; and
programming circuits for programming the group of memory cells in parallel, page by page, in order of the lower page, the middle page and then the upper page, said programming for each page increasing the threshold values of the group of memory cells in such a way that the respective set of read points for each of the lower, middle or upper pages is invariant irrespective of whether a higher order page has been programmed or not.

2. The non-volatile memory as in claim 1, wherein:
the eight memory states in order of increasing threshold value are {Er, A, B, C, D, E, F, G} that are demarcated by read points with threshold values as “A”, “B”, “C”, “D”, “E”, “F” and “G” respectively;
the eight memory states are encoded by a “2-3-2” coding with the 3-bit code words, (Upper bit, Middle bit, Lower bit), as {111, 110, 100, 101, 001, 000, 010, 011} respectively;
the invariant set of read points for the lower page is to read at “A” and “E”, with a read data being “1” if the memory cell is read as below “A” or at least “E”, or a read data being “0” if the memory cell is read as at least “A” and below “E”;
the invariant set of read points for the middle page is to read at “B”, “D” and “F”, with a read data being “1” if the memory cell is read as below “B” or at least “D” and below “F”, or a read data being “0” if the memory cell is read as at least “B” and below “D” or at least “F”; and
the invariant set of read points for the upper page is to read at “C” and “G”, with a read data being “1” if the memory cell is read as below “C” or at least “G”, or a read data being “0” if the memory cell is at least “C” and below “G”.

3. The non-volatile memory as in claim 1, wherein:
the eight memory states in order of increasing threshold value are {Er, A, B, C, D, E, F, G} that are demarcated by read points with threshold values as “A”, “B”, “C”, “D”, “E”, “F” and “G” respectively;
the eight memory states are encoded by a “2-3-2” coding with the 3-bit code words, (Upper bit, Middle bit, Lower bit), as {111, 110, 100, 101, 001, 000, 010, 011} respectively;
when only the lower page has been programmed, the memory cells targeted for {Er, E, F, G} have their threshold values unchanged and equal to those of the erased state {Er} and the memory cells targeted for {A, B, C, D} have threshold values increased to just below that of {A};
when only the lower and middle pages have been programmed, the memory cells targeted for {Er, E} has their threshold values unchanged and are equal to those of the erased state {Er}, the memory cells targeted for {F, G} have their threshold values increased to just below that of {F}, the memory cells targeted for {A, D} have their threshold values unchanged;, the memory cells targeted for {B,C} have their threshold values increased to just below that of {B}; and
when all of the lower, middle and upper pages have been programmed, the memory cells targeted for {Er, A, B, C, D, E, F, G} have their thresholds adjusted to corresponding to that of {Er, A, B, C, D, E, F, G}.

4. The non-volatile memory as in claim 1, wherein:
the eight memory states in order of increasing threshold value are {Er, A, B, C, D, E, F, G} that are demarcated by read points with threshold values as “A”, “B”, “C”, “D”, “E”, “F” and “G” respectively;
the eight memory states are encoded by a “4-2-1” coding with the 3-bit code words, (Upper bit, Middle bit, Lower bit), as {111, 110, 100, 101, 001, 000, 010, 011} respectively;
the invariant set of read points for the lower page is to read at “A”, “C”, “E” and “G”, with a read data being “1” if the memory cell is read as below “A” or at least “C” and below “E”, or at least “G”, or a read data being “0” if the memory cell is read as at least “A” and below “C” or at least “E” and below “G”;
the invariant set of read points for the middle page is to read at “B” and “F”, with a read data being “1” if the memory cell is read as below “B” or at least “F”, or a read data being “0” if the memory cell is read as at least “B” and below “F”; and
the invariant set of read points for the upper page is to read at “D”, with a read data being “1” if the memory cell is read as below “D”, or a read data being “0” if the memory cell is read as at least “D”.

5. The non-volatile memory as in claim 1, wherein:
the eight memory states in order of increasing threshold value are {Er, A, B, C, D, E, F, G} that are demarcated by read points with threshold values as “A”, “B”, “C”, “D”, “E”, “F” and “G” respectively;
the eight memory states are encoded by a “4-2-1” coding with the 3-bit code words, (Upper bit, Middle bit, Lower bit), as {111, 110, 100, 101, 001, 000, 010, 011} respectively;
when only the lower page has been programmed, the memory cells targeted for {Er, C, D, G} have their threshold values unchanged and equal to those of the erased state {Er} and the memory cells targeted for {A, B, E, F} have threshold values increased to just below that of {A};
when only the lower and middle pages have been programmed, the memory cells targeted for {Er, G} have their threshold values unchanged and equal to those of the erased state {Er}, the memory cells targeted for {A, F} have their threshold values increased to just below that of {A}, the memory cells targeted for {B, E} has their threshold values increased to just below that of {B}, the memory cells targeted for {C, D} have their threshold values increased to just below that of {C}; and
when all of the lower, middle and upper pages have been programmed, the memory cells targeted for {Er, A, B, C, D, E, F, G} have their thresholds adjusted to corresponding to that of {Er, A, B, C, D, E, F, G}.

6. The non-volatile memory as in claim 1, wherein:
the eight memory states in order of increasing threshold value are {Er, A, B, C, D, E, F, G} that are demarcated by read points with threshold values as “A”, “B”, “C”, “D”, “E”, “F” and “G” respectively;
the eight memory states are encoded by a “2-1-4” coding with the 3-bit code words, (Upper bit, Middle bit, Lower bit), as {111, 110, 100, 101, 001, 000, 010, 011} respectively;
the invariant set of read points for the lower page is to read at “B” and “F”, with a read data being “1” if the memory cell is read as below “B” or at least “F”, or a read data being “0” if the memory cell is read as at least “B” and below “F”;
the invariant set of read points for the middle page is to read at “D”, with a read data being “1” if the memory cell is read as below “D”, or a read data being “0” if the memory cell is read as at least “D”.
the invariant set of read points for the upper page is to read at “A”, “C”, “E” and “G”, with a read data being “1” if the memory cell is read as below “A” or at least “C and below “E”, or at least “G”, or a read data being “0” if the memory cell is read as at least “A” and below “C” or at least “E” and below “G”.

7. The non-volatile memory as in claim 1, wherein:
the eight memory states in order of increasing threshold value are {Er, A, B, C, D, E, F, G} that are demarcated by read points with threshold values as “A”, “B”, “C”, “D”, “E”, “F” and “G” respectively;
the eight memory states are encoded by a “2-1-4” coding with the 3-bit code words, (Upper bit, Middle bit, Lower bit), as {111, 110, 100, 101, 001, 000, 010, 011} respectively;
when only the lower page has been programmed, the memory cells targeted for {Er, A, F, G} have their threshold values unchanged and equal to those of the erased state {Er} and the memory cells targeted for {B, C, D, E} have threshold values increased to just below that of state {B};
when only the lower and middle pages have been programmed, the memory cells targeted for {Er, A} have their threshold values unchanged and equal to those of the erased state {Er}, the memory cells targeted for {F, G} have their threshold values increased to just below that of {F}, the memory cells targeted for {B, C} have their threshold values unchanged, the memory cells targeted for {D, E} have their threshold values increased to just below that of {E}, and
when all of the lower, middle and upper pages have been programmed, the memory cells targeted for {Er, A, B, C, D, E, F, G} have their thresholds adjusted to corresponding to that of {Er, A, B, C, D, E, F, G}.

8. The non-volatile memory as in claim 1, wherein:
said array of memory cells is arranged in a two-dimensional pattern.

9. The non-volatile memory as in claim 1, wherein:
said array of memory cells is arranged in a three-dimensional pattern.

10. The non-volatile memory as in claim 1, wherein:
said array of memory cells is arranged in an NAND architecture.

11. A non-volatile memory, comprising:
an array of memory cells, wherein individual memory cells are each in one of eight memory states, the eight memory states being an erase state and seven programmed states with increasing threshold values across a threshold window;
a group of data latches for storing each bit of a 3-bit code word for each memory cell among a group of memory cells operating in parallel, the 3-bit code word being one of eight 3-bit code words generated from a 3-bit code to encode the eight memory states;
the 3-bit code being constituted from a lower bit, a middle bit and an upper bit, wherein a lower page, middle page and upper page of data are respectively constituted from the lower bit, middle bit and upper bit of each memory cell among the group;
read circuits for reading page by page, the lower, middle or upper pages each being read by reference to a respective set of read points of predetermined threshold values;
programming circuits for programming the group of memory cells in parallel, page by page, in order of the lower page, the middle page and then the upper page; and
wherein the respective set of read points for each of the lower, middle or upper pages is invariant irrespective of whether a higher order page has been programmed or not.

12. A method of operating a non-volatile memory, comprising:
providing a two-dimensional or three dimensional array of memory cells;
partitioning a threshold window of each of the individual memory cells into one of eight memory states, the eight memory states being an erase state and seven programmed states;
encoding the eight memory states with eight 3-bit code words with a predefined ordering; each 3-bit code word having a lower bit, a middle bit and an upper bit, and wherein a group of memory cells has a lower page, middle page and upper page of data are respectively constituted from the lower bit, middle bit and upper bit of each memory cell among the group;
programming the group of memory cells in parallel, page by page, in order of the lower page, the middle page and then the upper page, said programming for each page increasing the threshold value of the group of memory cells in such a way that the respective set of read points for each of the lower, middle or upper pages is invariant irrespective of whether a higher order page has been programmed or not; and
reading page by page, the lower, middle or upper pages, each being read by reference to a respective set of read points of predefined threshold values.

13. The method of operating a non-volatile memory as in claim 12, wherein:
the eight memory states in order of increasing threshold value are {Er, A, B, C, D, E, F, G} that are demarcated by read points with threshold values as “A”, “B”, “C”, “D”, “E”, “F” and “G” respectively; and the method further comprising:
encoding the eight memory states by a “2-3-2” coding with the 3-bit code words, (Upper bit, Middle bit, Lower bit), as {111, 110, 100, 101, 001, 000, 010, 011} respectively;
reading the lower page with the invariant set of read points for the lower page by reading at “A” and “E”, with a read data being “1” if the memory cell is read as below “A” or at least “E”, or a read data being “0” if the memory cell is read as at least “A” and below “E”;
reading the middle page with the invariant set of read points for the middle page by reading at “B”, “D” and “F”, with a read data being “1” if the memory cell is read as below “B” or at least “D” and below “F”, or a read data being “0” if the memory cell is read as at least “B” and below “D” or at least “F”; and
reading the upper page with the invariant set of read points for the upper page by reading at “C” and “G”, with a read data being “1” if the memory cell is read as below “C” or at least “G”, or a read data being “0” if the memory cell is at least “C” and below “G”.

14. The method of operating a non-volatile memory as in claim 12, wherein:
the eight memory states in order of increasing threshold value are {Er, A, B, C, D, E, F, G} that are demarcated by read points with threshold values as “A”, “B”, “C”, “D”, “E”, “F” and “G” respectively; and the method further comprising:
encoding the eight memory states by a “2-3-2” coding with the 3-bit code words, (Upper bit, Middle bit, Lower bit), as {111, 110, 100, 101, 001, 000, 010, 011} respectively;
programming the lower page, such that the memory cells targeted for {Er, E, F, G} have their threshold values unchanged and are equal to those of the erased state {Er} and the memory cells targeted for {A, B, C, D} have threshold values increased to just below that of {A};
programming the middle page subsequent to having programmed the lower page, such that the memory cells targeted for {Er, E} has their threshold values unchanged and equal to those of the erased state {Er}, the memory cells targeted for {F, G} have their threshold values increased to just below that of {F}, the memory cells targeted for {A, D} have their threshold values unchanged, and the memory cells targeted for {B,C} have their threshold values increased to just below that of {B}; and
programming the upper page subsequent to having programmed the lower and middle pages, such that the memory cells targeted for {Er, A, B, C, D, E, F, G} have their thresholds adjusted to corresponding to that of {Er, A, B, C, D, E, F, G}.

15. The method of operating a non-volatile memory as in claim 12, wherein:
the eight memory states in order of increasing threshold value are {Er, A, B, C, D, E, F, G} that are demarcated by read points with threshold values as “A”, “B”, “C”, “D”, “E”, “F” and “G” respectively; and the method further comprising:
encoding the eight memory states by a “4-2-1” coding with the 3-bit code words, (Upper bit, Middle bit, Lower bit), as {111, 110, 100, 101, 001, 000, 010, 011} respectively;
reading the lower page with the invariant set of read points for the lower page by reading at “A”, “C”, “E” and “G”, with a read data being “1” if the memory cell is read as below “A” or at least “C” and below “E”, or at least “G”, or a read data being “0” if the memory cell is read as at least “A” and below “C” or at least “E” and below “G”;
reading the middle page with the invariant set of read points for the middle page by reading at “B” and “F”, with a read data being “1” if the memory cell is read as below “B” or at least “F”, or a read data being “0” if the memory cell is read as at least “B” and below “F”; and
reading the upper page with the invariant set of read points for the upper page by reading at “D”, with a read data being “1” if the memory cell is read as below “D”, or a read data being “0” if the memory cell is read as at least “D”.

16. The method of operating a non-volatile memory as in claim 12, wherein:
the eight memory states in order of increasing threshold value are {Er, A, B, C, D, E, F, G} that are demarcated by read points with threshold values as “A”, “B”, “C”, “D”, “E”, “F” and “G” respectively; and the method further comprising:
encoding the eight memory states by a “4-2-1” coding with the 3-bit code words, (Upper bit, Middle bit, Lower bit), as {111, 110, 100, 101, 001, 000, 010, 011} respectively;
programming the lower page, such that the memory cells targeted for {Er, C, D, G} have their threshold values unchanged and equal to those of the erased state {Er} and the memory cells targeted for {A, B, E, F} have threshold values increased to just below that of {A};
programming the middle page subsequent to having the lower page programmed, such that the memory cells targeted for {Er, G} has their threshold values unchanged and equal to those of the erased state {Er}, the memory cells targeted for {A, F} have their threshold values increased to just below that of {A}, the memory cells targeted for {B, E} has their threshold values increased to just below that of {B}, and the memory cells targeted for {C, D} have their threshold values increased to just below that of {C}; and
programming upper page subsequent to having the lower and upper pages programmed, such that the memory cells targeted for {Er, A, B, C, D, E, F, G} have their thresholds adjusted to corresponding to that of {Er, A, B, C, D, E, F, G}.

17. The method of operating a non-volatile memory as in claim 12, wherein:
the eight memory states in order of increasing threshold value are {Er, A, B, C, D, E, F, G} that are demarcated by read points with threshold values as “A”, “B”, “C”, “D”, “E”, “F” and “G” respectively; and the method further comprising:
encoding the eight memory states by a “2-1-4” coding with the 3-bit code words, (Upper bit, Middle bit, Lower bit), as {111, 110, 100, 101, 001, 000, 010, 011} respectively;
reading the lower page with the invariant set of read points for the lower page by reading at “B” and “F”, with a read data being “1” if the memory cell is read as below “B” or at least “F”, or a read data being “0” if the memory cell is read as at least “B” and below “F”;
reading the middle page with the invariant set of read points for the middle page by reading at “D”, with a read data being “1” if the memory cell is read as below “D”, or a read data being “0” if the memory cell is read as at least “D”.
reading the upper page with the invariant set of read points for the upper page by reading at “A”, “C”, “E” and “G”, with a read data being “1” if the memory cell is read as below “A” or at least “C and below “E”, or at least “G”, or a read data being “0” if the memory cell is read as at least “A” and below “C” or at least “E” and below “G”.

18. The method of operating a non-volatile memory as in claim 12, wherein:
the eight memory states in order of increasing threshold value are {Er, A, B, C, D, E, F, G} that are demarcated by read points with threshold values as “A”, “B”, “C”, “D”, “E”, “F” and “G” respectively; and the method further comprising:
encoding the eight memory states by a “2-1-4” coding with the 3-bit code words, (Upper bit, Middle bit, Lower bit), as {111, 110, 100, 101, 001, 000, 010, 011} respectively;
programming the lower page, such that the memory cells targeted for {Er, A, F, G} have their threshold values unchanged and equal to those of the erased state {Er} and the memory cells targeted for {B, C, D, E} have threshold values increased to just below that of state {B};
programming the middle page subsequent to having the lower page programmed, such that the memory cells targeted for {Er, A} have their threshold values unchanged and equal to those of the erased state {Er}, the memory cells targeted for {F, G} have their threshold values increased to just below that of {F}, the memory cells targeted for {B, C} have their threshold values unchanged, and the memory cells targeted for {D, E} have their threshold values increased to just below that of {D}, and
programming the upper page subsequent to having the lower and middle pages programmed, such that the memory cells targeted for {Er, A, B, C, D, E, F, G} have their thresholds adjusted to corresponding to that of {Er, A, B, C, D, E, F, G}.

19. The method of operating a non-volatile memory as in claim 12, wherein:
said array of memory cells is arranged in an NAND architecture.
